(19) United States
(12) Patent Application Publication
(10) Pub. No.: US 2015/0237684 A1
(43) Pub. Date: Aug. 20, 2015

(54) MICROWAVE-BASED MATERIAL PROCESSING SYSTEMS AND METHODS

(71) Applicant: FWD:ENERGY, INC., LAS VEGAS, NV (US)

(72) Inventor: Scott Emerson Huber, Canal Winchester, OH (US)

(21) Appl. No.: 14/628,164

(22) Filed: Feb. 20, 2015

Related U.S. Application Data
(60) Provisional application No. 61/942,183, filed on Feb. 20, 2014.
(60) Provisional application No. 62/042,289, filed on Aug. 27, 2014.
(60) Provisional application No. 62/060,114, filed on Oct. 6, 2014.

(51) Int. Cl. H05B 6/78

(52) U.S. Cl. CPC H05B 6/786

(57) ABSTRACT

Systems and methods for heating, converting, reclaiming, or otherwise processing materials by means of microwave irradiation. The materials to be processed are moved through the system by means of a vibratory conveyor. Other system components may be isolated from the vibratory motion effects of the vibratory conveyor.

### CROSS-REFERENCE TO RELATED APPLICATIONS

This application claims the benefit of U.S. Provisional Application No. 61/942,183, filed on Feb. 20, 2014; U.S. Provisional Application No. 62/042,289, filed on Aug. 27, 2014; and U.S. Provisional Application No. 62/060,114, filed on Oct. 6, 2014, all of which are hereby incorporated by reference as if fully recited herein.

### TECHNICAL FIELD

Exemplary system and method embodiments described herein are directed to the heating, converting, reclaiming or otherwise processing of materials by means of microwave irradiation.

### BACKGROUND

The problems surrounding product waste streams are well known, and various disposal solutions have been posed over time. Many of the materials in these waste streams will decompose rapidly and pose little to no environmental hazard. Therefore, such materials may be well-suited to disposal in a conventional landfill. However, the disposal of other waste stream materials is more problematic, as such materials may exhibit an extremely lengthy decomposition time and/or pose an environmental hazard.

With respect especially to materials that exhibit an extremely lengthy decomposition time and/or pose an environmental hazard, it is desirable to develop alternative end-of-life solutions that include recycling, reuse, or disposal in a manner that will preferably hasten the time required for decomposition and eliminate or lessen the environmental impact resulting from their disposal. As should also be apparent, it would be advantageous if such end-of-life solutions result in commercially viable and useful materials and derivative byproducts.

Outside of waste stream processing, there are many other settings in which a material may need to be heated, which heating may be accompanied by dewatering, drying, or sterilization prior to its end use or prior to further processing. These settings may include, for example and without limitation industrial or building materials manufacturing, food processing, wastewater treatment, environmental remediation, coal gasification and energy feedstock development.

One tried technique for disposing of problematic waste stream materials is heat-based treatment, such as incineration or pyrolysis. Early efforts in this regard generally involved heating/burning a waste material of interest in a furnace or other vessel. This technique has proven suboptimal, however, at least based on the cost of disposal and on environmental concerns.

Similarly, the known techniques for heating, dewatering, drying and sterilizing other materials, while useable, are problematic, expensive and/or inefficient. For example, heating or drying commonly involves the application of heat derived directly from the burning of fossil fuels. The dewatering of materials such as wastewater sludge typically involves squeezing water from the sludge material using a complex and expensive belt press or similar apparatus, a process that also requires the addition of an expensive polymer coagulant to the sludge. In lieu of or in addition to the use of a belt press apparatus, sludge may also be dewatered in disposable geotextile dewatering bags or spread within special dewatering pits, both of which require significant space, result in a slow dewatering process, and also require the addition of a polymer coagulant.

The remediation of environmentally hazardous materials often requires the use of complex systems and processes, as well as the removal and transport of the hazardous material to an off-site location prior to treatment. As a result, known environmental remediation practices can be quite costly and time consuming.

More recently, microwave-based systems and methods for treating or processing waste stream and other materials have been developed. In these systems and methods, microwave energy is directed at a material of interest as it is maintained in a stationary position within a microwave apparatus or as the material is moved through a microwave apparatus on a conveyor belt. The microwave energy efficiently heats, dries, and/or otherwise processes the waste or other material in a manner that is dependent on the material at issue, the intended result of the treatment, and the specific method of treatment.

With respect to waste processing, there are a number of waste stream materials that may lend themselves well to microwave-based conversion. When the waste material is a carbonaceous material, the microwave energy acts to convert the carbonaceous material into various other solid, liquid and gaseous materials, such as carbon black, oil, and gaseous hydrocarbons. One carbonaceous waste stream material of particular interest is scrap tires and waste rubber.

The rubber compounds from which vehicle tires are made are very durable and may take hundreds of years to decompose. Further, the rubber compounds in tires also contain materials that can be hazardous to the environment and may be highly flammable, which has in the past led to large tire pile fires that have burned for extended periods of time. Scrap tires are also notorious collectors of rain water and are a known breeding ground for mosquitoes and West Nile virus. For at least these reasons, it is particularly undesirable to bury scrap tires in traditional landfills. Because of the difficulty and dangers associated with tire disposal, the lengthy decomposition period associated with tire materials, and the nearly one billion tires that are disposed of annually, the number of scrap tires available for microwave-based conversion may be in the hundreds of millions or more.

While microwave-based systems and methods of material processing may be superior to many corresponding traditional processing methods, known microwave-based techniques are not without problems. These problems include, without limitation, the ability to finely control movement of the material through a microwave application section of a system, and ensuring even heating, conversion or other processing of the layer of material that is subjected to microwave irradiation. Exemplary system and method embodiments described and shown herein overcome these and other problems associated with known microwave-based material processing systems and methods.

### SUMMARY

Exemplary embodiments of the invention involve systems and methods for the microwave heating, conversion or other processing or treatment of materials. In a most simplistic exemplary embodiment, a material of interest is heated to elevate its temperature by subjecting the material to microwave irradiation. The irradiation process may occur in an oxygen-containing environment or in an inert and substantially oxygen free environment. One particular example of such a heating embodiment is a sterilization embodiment, wherein a material to be sterilized is subjected to microwave irradiation in an inert and substantially oxygen free environment and its temperature is raised to a point sufficient to eliminate certain possible contaminants, bacteria, etc. One non-limiting example of a material that is well-suited to sterilization by microwave irradiation is a foodstuff.

Another exemplary embodiment is a dewatering embodiment, wherein a material to be dewatered may be subjected to microwave irradiation for the purpose of removing some amount of water therefrom. A pre-irradiation dewatering grate or another similar mechanism(s) may be employed upstream of the microwave applicator portion of the associated system to assist with dewatering. One non-limiting example of a material that is well-suited to dewatering by microwave irradiation is wastewater sludge. In such an application, water is removed from the wet sludge material by microwave heating with the intent to produce a processed sludge that is sufficiently dried and sterilized for landfill deposit or a dewatered cake that is sufficiently dry for incineration (i.e., may be a semi-solid). Microwave processing of wastewater sludge may also provide the benefit of eradicating bacteria or other objectionable sludge ingredients, possibly rendering the sludge acceptable for use as a fertilizer or otherwise sufficiently innocuous for alternative disposal methods. A dewatering system and method embodiment may also be well-suited for removing moisture from coal prior to its pulverization and/or burning as a fuel.

Another exemplary embodiment is a sorting/sifting embodiment, wherein a material to be heated or dried may be sorted/sifted prior to being subjected to and heated by microwave irradiation. In one such exemplary embodiment, the material of interest may pass over a sorting/sifting grate or screen while being conveyed to a microwave applicator portion of the system. This allows smaller, deleterious or otherwise undesirable elements of the material of interest to be removed prior to microwave irradiation, leaving only the desirable portion of the material of interest remaining. The sorted/sifted material may be routed to another location, and may be collected separately from the irradiated material of interest, etc. Non-limiting examples of such system and method embodiments of the invention may find use in cement kilns and asphalt plants, in the treatment of wastewater sludge, in the remediation of contaminated soils, and in processes for preparing coal or sterilizing foodstuffs.

Yet another exemplary embodiment is directed to the drying of a material of interest with the additional use of a fluidized bed. Particularly, the conveyor by which the material is transported through the system, or at least through the microwave applicator section thereof, is part of a fluidized bed by which warm air from a heat source is directed through the underside of the conveyor to assist with drying. A plenum may be provided below the conveyor to receive and distribute the warm air through the conveyor. Non-limiting examples of such system and method embodiments of the invention may find use in the treatment of wastewater sludge, in the remediation of contaminated soils, and in processes for preparing coal or sterilizing foodstuffs.

Another particularly interesting embodiment is directed to the microwave conversion of a carbonaceous material into useful end products. One non-limiting example of a carbonaceous material that is well-suited to microwave conversion, is the rubber compound of common vehicle tires. Exemplary system and method embodiments described herein may be used to convert scrap vehicle tires into desirable products such as, for example, synthetic gas and synthetic crude oil or products derived therefrom, and commodity products such as carbon black and activated carbon. More specifically, the microwave energy supplied by an exemplary system efficiently excites the molecules within the scrap tire material to a point where molecular bonds are broken, allowing for the reclamation of desirable products inherent in the tire material, such as those products described above.

Exemplary system embodiments may be designed and operated to provide stand-alone heating, conversion, reclamation or other material processing functionality. Furthermore, exemplary system embodiments according to the invention may be made portable so as to be delivered to and operated at or near the location of a given material to be treated. Portability may be especially beneficial in, for example, embodiments used to remediate contaminated soil, etc.

In a most simplistic form, an exemplary system embodiment may include a microwave applicator chamber, and a vibratory conveyor located and adapted to receive a feedstock in the form of a material of interest and to transport the material of interest through the microwave applicator chamber as the material is irradiated with microwave energy. The vibratory conveyor may receive the material of interest within the microwave applicator chamber at a receiving end and transport the material to a discharge end. Such a system may include a feed hopper or a comparable device for controllably supplying the material of interest. The material being processed may be directed through a sealed inlet mechanism or otherwise delivered into a gas-tight microwave applicator chamber that is purged of oxygen with a gas, which may be an inert or other gas, or that is evacuated to some negative pressure. In other embodiments, the microwave applicator chamber may not be gas tight and may be non-purged. Such a system may also include microwave energy containment devices to prevent the migration of microwave energy from the microwave applicator chamber.

Other exemplary system embodiments may include a microwave applicator chamber, a material receiving section that is located upstream of the microwave applicator chamber, and possibly a discharge and/or cooling section that is located downstream from the microwave applicator chamber. A vibratory conveyor is again provided to transport the material of interest through the microwave applicator chamber as the material is irradiated with microwave energy. The material receiving section of such an exemplary system may be located within an enclosure, along with the microwave applicator chamber and, optionally, a discharge and/or cooling section. In such an embodiment, the material being processed may be directed through a sealed inlet mechanism or otherwise delivered into a gas-tight material receiving section. The discharge end of the microwave applicator chamber or the discharge end of the discharge and/or cooling section of the system may also be made gas tight, such that the enclosure may be purged of oxygen with a gas, which may be an inert or other gas, or may be evacuated to some negative pressure. Alternatively, the material receiving section of such an exemplary system may be open to the atmosphere, whereby material to be processed may be deposited directly onto an exposed conveyor belt, a receiving portion of the vibratory conveyor, or some other material infeed mechanism. Such a system embodiment may also, but will not necessarily, have a feed hopper or a comparable device for receiving and controllably supplying the material of interest. In some exemplary system embodiments, the material of interest is pre-heated by ambient heat in the receiving section and then moved into and through the microwave applicator chamber, where the material is irradiated with microwave energy.

After being sufficiently irradiated to result in satisfactory heating, dewatering, drying, sterilization, conversion, reclamation, etc., of the material being processed, the material may in some embodiments be moved into a cooling section of the system. In other cases, a system cooling section and an associated cooling process may be omitted. In any case, the processed material is eventually discharged from the system, such as by being conveyed to a discharge port and deposited into collection vessels, etc. Liquid and/or gaseous byproducts of conversion may also be removed from certain embodiments of the system at various times and locations. Exemplary system embodiments may include a microwave applicator section that operates at substantially ambient pressure, at a positive pressure, or under vacuum.

Regardless of the particular purpose for irradiating a material of interest, the material is transported through the associated system in a highly novel manner. Particularly, in contrast to known microwave irradiation systems that utilize endless loop conveyor belts, removable trays, etc., to present material to and remove material from a microwave applicator, the exemplary system embodiments described herein make use of a vibratory material transport mechanism. Generally speaking, the vibratory material transport mechanism is a vibratory conveyor having a vibratory drive system that is in communication with a conveying trough or table upon which the material of interest rests and moves. The vibratory conveyor may extend the full length of the system—from a receiving section, through a microwave application section, and into and into a material discharge (and optional cooling) section. Alternatively, the vibratory conveyor may be used only in the microwave application section, with the material of interest being transferred to and from the vibratory conveyor by other means.

In any case, the vibratory drive system of the vibratory conveyor allows the movement of the material along the conveyor trough/table to be finely controlled. Both very fast and very slow transport speeds are achievable, as is virtually any speed in between, and material transport programs comprising a combination of various material transport speeds may be employed. Furthermore, unlike traditional material transport mechanisms such as belt conveyors, the use of a vibratory conveyor allows the material of interest to be mixed by vibration while being transported through the system. The material of interest may also be mixed by vibration of the vibratory conveyor when the material is in a stationary state with respect to forward or rearward movement thereof. Such mixing promotes a more even absorption of microwave energy by the material, from the top to the bottom of the material layer, thereby resulting in a more efficient overall use of the microwave energy. The use of a vibratory conveyor also eliminates the return path required by an endless belt conveyor and the complexities, limitations and inefficiencies associated with the use of removable trays.

In regard to mixing and evenly applying microwave energy to a material of interest, it is also possible for the trough/table of a vibratory conveyor of a system embodiment to be provided with one or more ramps or similar features along its length, at least in the area of microwave application. These ramps act to further mix the material by causing a tumbling thereof, and also variably alter the distance of the material from the microwave source(s) as the material moves through the microwave applicator section.

The trough/table of a vibratory conveyor of a system of the invention may be provided with one or more directing channels or other guideways in addition to or in lieu of the aforementioned ramps. These material directing channels function to cause a movement of the material of interest in a direction other than the normal conveying direction. More specifically, the material directing channels are sized and oriented to cause at least a portion of the material of interest to move transversely (e.g., laterally or diagonally) to the normal conveying direction as the material moves through the microwave application section. The effect of this transverse movement is to additionally mix the material of interest so as to further promote the absorption of microwave energy thereby.

Embodiments of the invention also include novel designs for isolating various system components from the oscillating effects of the vibratory conveyor. For example, a specialized design and construction allows the waveguides of the microwave applicator to be secured in a stationary manner while simultaneously being isolated from the effects of the vibratory conveyor. A unique expansion joint construction is employed for this purpose. At least when used for isolating microwave applicator waveguides, the expansion joints are preferably of metal construction so as to contain both emitted microwave energy and any vapors that are produced during material treatment. A similar design and construction may also be used to isolate other, upstream and/or downstream, components.

While, as noted above, a particularly interesting use of a system and method of the invention is the microwave conversion of scrap vehicle tires, it is to be understood that system and method embodiments of the invention are not limited to the conversion of tire material. Rather, exemplary systems and methods may be used to process (e.g., heat, dry, convert, pyrolize, sterilize, etc.) a variety of materials, including but not limited to, scrap tires, waste rubber from other products or manufacturing processes, waste plastics and polymers, asphalt shingles, e-waste, medical waste, municipal sludge, oil/shale drilling waste, coal (e.g., for gasification), and foodstuffs. It is contemplated that systems and methods of the invention may also serve a role in more complex systems and processes for producing activated carbon from one or more of various carbonaceous materials that would be well known to one of skill in the art.

Other aspects and features of the invention will become apparent to those skilled in the art upon review of the following detailed description of exemplary embodiments along with the accompanying drawing figures.

### BRIEF DESCRIPTION OF THE DRAWINGS

In the following descriptions of the drawings and exemplary embodiments, like reference numerals across the several views refer to identical or equivalent features, wherein:

FIG. 1 is a transparent side view of one exemplary embodiment of a microwave-based material processing system;

FIG. 2 is an enlarged end view taken along Section 1, as indicated in FIG. 1;

FIG. 3 is an enlarged end view taken along Section 2, as indicated in FIG. 1;

FIG. 4 is a transparent side view of another exemplary embodiment of a microwave-based material processing system designed to perform a dewatering operation;

FIG. 5 is a transparent side view of another exemplary embodiment of a microwave-based material processing system designed to perform a sterilizing operation;

FIG. 6 is a transparent side view of another exemplary embodiment of a microwave-based material processing system that includes sorting/sifting functionality;

FIG. 7 is a transparent side view of another exemplary embodiment of a microwave-based material processing system that includes a fluidized bed microwave applicator and is designed to perform a drying operation;

FIGS. 8A-8B are a side view and a front view, respectively, of one exemplary embodiment of a pass-through microwave energy containment device;

FIGS. 9A-9B illustrate possible but non-limiting cross-sectional shapes of exemplary pass-through microwave energy containment devices and the components thereof;

FIG. 10 is a transparent side view of an alternative exemplary embodiment of a microwave-based material processing system for converting scrap tire material;

FIG. 11 is a transparent side view of an alternative exemplary embodiment of a microwave-based material processing system for performing a dewatering operation, the system employing pass-through microwave energy containment devices such as the device depicted in FIGS. 8A-8B;

FIG. 12 is a transparent side view of an alternative exemplary embodiment of a microwave-based material processing system for performing a sterilizing operation, the system employing pass-through microwave energy containment devices such as the device depicted in FIGS. 8A-8B;

FIG. 13 is a transparent side view of an alternative exemplary embodiment of a microwave-based material processing system that includes sorting/sifting functionality, the system employing pass-through microwave energy containment devices such as the device depicted in FIGS. 8A-8B;

FIG. 14 is a transparent side view of an alternative exemplary embodiment of a microwave-based material processing system for performing a drying operation, and which includes a fluidized bed microwave applicator, the system employing pass-through microwave energy containment devices such as the device depicted in FIGS. 8A-8B;

FIG. 15 is a transparent side view of an exemplary embodiment of a simplified microwave-based material processing system; and

FIG. 16 is an enlarged view of a vibratory isolator being used to isolate a waveguide of the system from the effects of vibratory movement.

### DETAILED DESCRIPTION OF EXEMPLARY EMBODIMENT(S)

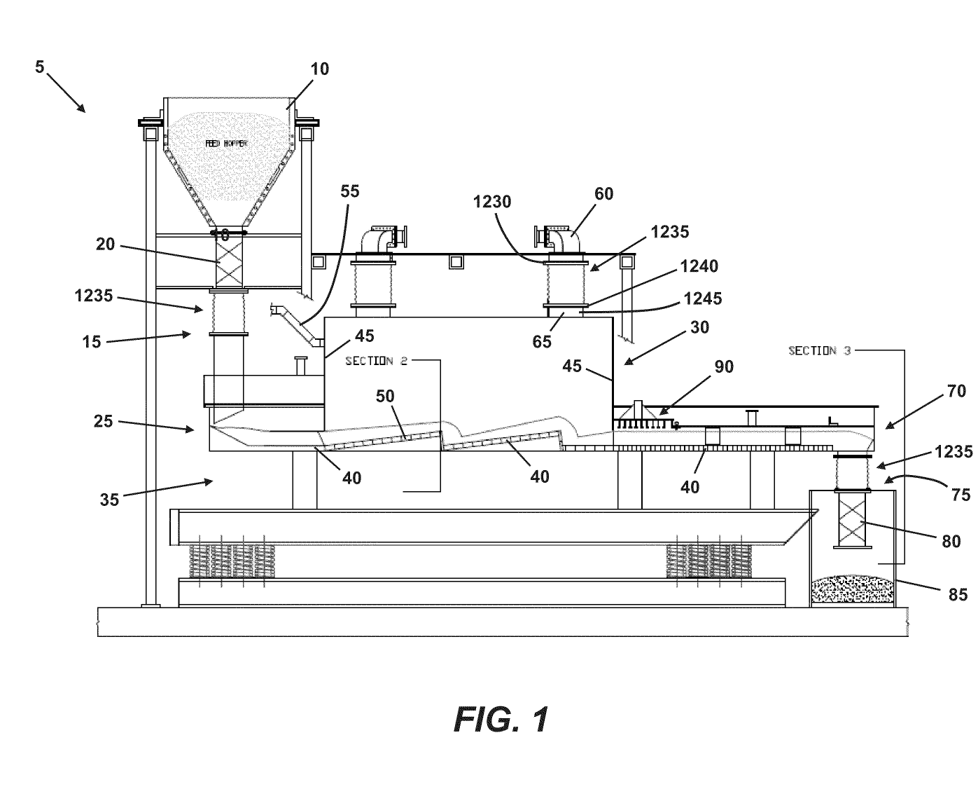

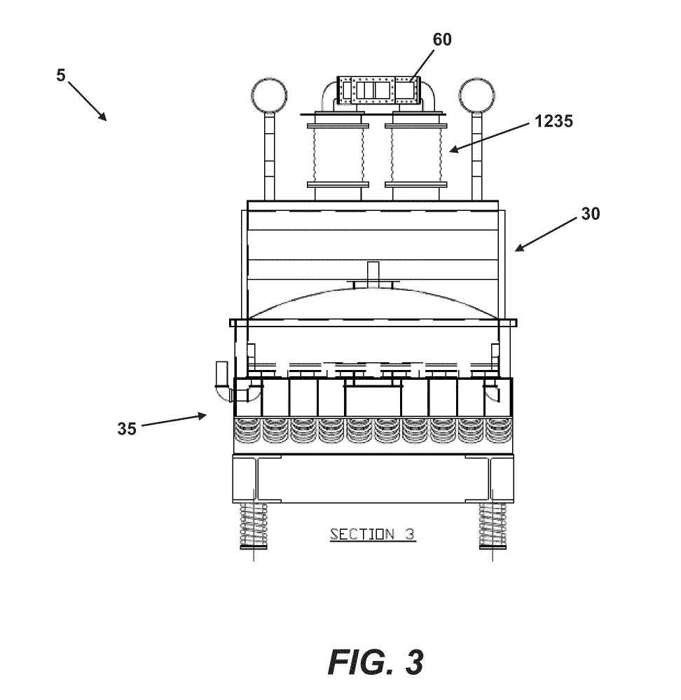

Various exemplary embodiments of microwave-based material processing systems according to the invention are depicted in FIGS. 1-7 and 10-15. As described above, exemplary microwave irradiation systems and methods according to the invention may be used in applications such as heating, dewatering, drying, sterilizing, and converting in settings that may include, for example and without limitation, solid waste treatment (e.g., scrap tire conversion), industrial or building materials manufacturing, food processing, wastewater treatment, environmental remediation, coal gasification and energy feedstock development (e.g., drying algae or cellulosic wood pulp to create an energy-producing feedstock for other processes). However, other embodiments are also possible and, therefore, these exemplary embodiments are not to be construed as limiting in scope.

In each of the exemplary embodiments shown in FIGS. 1-7 and 10-15 and described below, the material being processed (i.e., the feedstock) is transported through the system, or at least through a microwave applicator portion of the system, by means of a vibratory conveyor having a vibratory drive system that is in motive communication with a material-carrying portion (e.g., a conveying trough or table) upon which the feedstock material rests and moves. The vibratory drive system may reside beneath the material-carrying portion or in a location other than beneath the material-carrying portion in different system embodiments. The vibratory drive system may include one or more vibratory motors for initiating and sustaining the driving motion of the conveyor, but embodiments of the invention are not limited to any particular vibratory drive system design. In any case, the vibratory drive system is normally operative to produce the overall vibrating motion that induces movement of the feedstock.

In some system embodiments, the vibratory conveyor may be a single conveyor, such that the entirety or substantially the entirety of the material-carrying portion upon which the feedstock material rests and moves vibrates in the same manner as a result of operation of the vibratory drive system. In other embodiments, the vibratory conveyor may include separate conveyor sections comprised of independent vibratory conveyors, each having its own vibratory drive system. In this manner, it is possible to impart dissimilar vibratory characteristics to the material being processed at different locations within the system.

A variable frequency drive is also preferably used to control the vibratory conveyor so as to allow for a wide range of possible conveying speeds. When multiple vibratory conveyors are employed, as described above, variable frequency drives may also be employed. In any case, both very fast and very slow material transport speeds are achievable, as is virtually any speed in between, and material transport programs comprising a combination of various material transport speeds may be employed. It is also possible to produce both a gentle forward motion of the material or a more abrupt and severe jump forward. Furthermore, use of the vibratory conveyor and its associated variable frequency drive allows the feedstock material of interest to be mixed by vibration while being transported through the system, or to be mixed by vibration while held in a stationary position. Such mixing promotes a more even heating of the material from the top to the bottom of the material layer.

The use of a vibratory conveyor also provides other benefits. For example, a vibratory conveyor a vibratory conveyor may be very energy efficient and can convey virtually any type of material. Vibratory conveyors are also inherently self-cleaning, experience very little wear of the conveying surface, and cause very little damage or degradation to the material being transported. Also, a vibratory conveyor is not subject to many of the problems that plague belt conveyors, such as material falling through the openings of a mesh-type belt conveyor and accumulating under the belt. This may be problematic in the case of a microwave-based material processing system because the accumulated material may superheat, creating temperature zones that may eventually challenge the integrity of the steel or other material used to construct microwave applicator chamber enclosures, etc. Unlike belt conveyors, vibratory conveyors do not expose various components such as rollers, pulleys, gears, etc., to extreme temperatures and other harsh conditions. If necessary, the conveying surface of a vibratory conveyor may also be easily modified to permit the conveying and processing of feedstock across a very wide temperature range (e.g., up to thousands of degrees Fahrenheit). For example, for this and other reasons, certain system embodiments may include a vibratory conveyor conveying surface that is lined with ceramic tiles or other materials that protect the conveying surface and/or aid in material movement across the conveying surface.

In some embodiments, the vibratory conveyor may extend the full length of the system—from a receiving section, through the microwave applicator, and into a post-irradiation (e.g., cooling and/or discharge) section. In other embodiments, the vibratory conveyor may extend only through the microwave applicator, with the material of interest being transferred thereto from a receiving section and/or being removed therefrom to a cooling chamber or post-irradiation section of the system by other means.

In each of the exemplary embodiments shown and described herein, it is also desirable to evenly apply microwave energy to the feedstock material during the processing thereof. To that end, the conveying surface of the vibratory conveyor upon which the feedstock material rests and moves may be optionally provided along its length with one or more ramps or similar material mixing features. The ramps act to further mix the feedstock material by causing a tumbling thereof as the material falls from one ramp to the next or from a ramp to a flat portion of the vibratory conveying surface. The ramps also have the effect of variably altering the distance of the feedstock material from the entry points and reflection points of the microwave energy within the microwave applicator chamber as the feedstock material moves therethrough.

In addition to locating ramps or some similar mixing mechanism along the conveying path of the feedstock material within the microwave applicator chamber, exemplary system embodiments may also be provided with one or more directing channels or other material guideways that function to cause a movement of the material of interest in a direction other than the normal conveying direction. More specifically, material directing channels may be provided and may be dimensioned and oriented to cause at least a portion of the material of interest to move transversely (e.g., laterally or diagonally) to the normal conveying direction as the material moves through the microwave application section. The effect of this movement is to further mix the material of interest so as to promote a more uniform absorption of microwave energy thereby. Such material directing channels or other guideways may be located in/on the conveying surface of the vibratory conveyor of the given system. The material directing channels may be located to pass over the conveying surface of the ramps, or the material directing channels may be arranged to avoid the ramps.

A first exemplary embodiment of a microwave-based material processing system 5 is depicted in FIGS. 1-3. As shown, this particular embodiment includes a feed hopper 10 for receiving and distributing a material (feedstock) of interest. In this embodiment, the feed hopper 10 is located directly above an inlet section 15 of the system 5. In other embodiments, the feed hopper 10 may be offset from the inlet section 15 of the system 5, in which case a conveyor, chute or some other device may be interposed between the feed hopper and the system inlet to transfer the feedstock therebetween.

The inlet section 15 of the system 5 may include a sealed inlet mechanism 20 (e.g., a rotary or double flap valve) that helps to create a gas-tight feedstock receiving chamber 25 within the system. The gas-tight feedstock receiving chamber 25 may be purged, preferably with an inert gas. In the exemplary embodiment shown herein, the feedstock receiving chamber 25 is also a pre-heat chamber that is operative to raise the temperature of the feedstock that resides therein prior to the feedstock being transferred to a downstream microwave applicator chamber 30 of the system 5. The pre-heat chamber 25 may include its own heat source and/or may receive heat collected from the downstream microwave applicator chamber 30 and/or a cooling chamber 70 of the system 5.

The feedstock is transferred from the pre-heat chamber 25 and transported through the system 5 by means of a vibratory conveyor 35 having a vibratory drive system that is in motive communication with a conveying trough (or table) 40 upon which the feedstock material rests and moves. The vibratory drive system is normally operative to produce the overall vibrating motion that induces movement of the feedstock. In this exemplary embodiment, the vibratory conveyor 35 extends the full length of the system 5—from the pre-heat chamber 25, through the microwave applicator chamber 30, and into the cooling and material removal chamber 70.

Referring particularly to FIG. 1, it can be seen that the applicator chamber 30 is a box-like structure having end walls 45, side walls and a top wall. The microwave applicator chamber 30 is preferably designed to prevent or reduce to an acceptable level, microwave energy leakage from the applicator chamber. Additionally, a pin-choke bed 90 or similar microwave blocking structure may be installed on either side of the applicator chamber or elsewhere to similarly inhibit or eliminate the migration of stray microwave energy into adjacent spaces.

The microwave applicator chamber 30 is shown to include a gas (vapor recovery) port 55 that is provided to vent gaseous byproducts of the microwave irradiation process from the microwave applicator chamber. In this exemplary embodiment, the vapor recovery port 55 is located on a side wall 45 of the microwave applicator chamber for purposes of illustration, but one or more vapor recovery ports may instead or also be located on a different applicator chamber wall in other embodiments. In any case, captured gaseous byproducts may be, condensed, scrubbed, and/or otherwise acted upon in various fashion. The captured gaseous byproducts may be sold or may be used as a fuel to generate electrical energy for powering the microwave applicator and or other components of the system 5. As with the pre-heat (receiving) chamber 25, the microwave applicator chamber 30 may be purged with a preferably inert gas so as to help reduce any chances of feedstock combustion or recombination of the off-gases with oxygen. Alternatively, at least the microwave applicator chamber 30 may be operated under vacuum—in which case it is preferable to ensure a good seal against the inflow of outside air.

The microwave applicator chamber 30 can also be seen to include microwave waveguides 60 that direct microwave energy from a microwave source (not shown) through corresponding entry points 65 in the overhead chamber wall. The waveguides and entry points may have other shapes, locations and orientations in other system embodiments. The waveguides may be protected from reflected microwave energy by any of the techniques that would be well known to one of skill in the art.

As best illustrated in FIG. 1, and for the purposes described above, the conveying surface (trough) 40 of this exemplary vibratory conveyor 35 upon which the feedstock material rests and moves is provided with one or more ramps 50 or similar features along its length. In addition to the locating ramps 50, the conveying surface 40 may also be provided with one or more directing channels or other guideways as described above, to cause a movement of the material of interest in a direction other than the normal conveying direction.

From the microwave applicator chamber 30, the remainder of the microwave irradiated feedstock material is transferred by the vibratory conveyor to a cooling chamber 70 where the material is allowed to cool sufficiently before being removed through an outlet section 75. It is expected that a majority if not all of the remaining material that is transferred to the cooling chamber 70 will be in solid form. However, this may not necessarily be the case depending on the nature of the feedstock material that is processed.

In a similar fashion to the inlet section 15, the outlet section 75 of the system 5 may include a sealed outlet mechanism 80 that helps to create a gas-tight cooling chamber 70. The cooling chamber 70 may also be purged, preferably with an inert gas.

As previously mentioned, scrap tires are a particularly attractive, but certainly not exclusive, feedstock material that may be processed by a system and method of the invention. In the case of scrap tire processing, the feed hopper 10 would receive a feedstock of shredded/pulverized tire material and direct the tire material through the sealed inlet mechanism 20 and into the pre-heat chamber 25, which is purged with an inert gas. After some predetermined amount of pre-heating, the tire material is moved into and through the microwave applicator chamber 30 by the vibratory conveyor 35. As the material passes through the microwave applicator chamber 30, it is heated by microwave irradiation to a desired temperature for a desired amount of time, so as to convert (depolymerize) the tire material.

The microwave energy will most likely be directed at the tire material feedstock from above the vibratory conveyor 35 and possibly also transversely thereto. The microwave energy will liberate the hydrocarbon content in the material to result in a hydrocarbon vapor that is split into gaseous and/or liquid fuels after exiting the microwave chamber 30, as well as commodity products such as carbon black that are inherent to the tire material as a result of the tire manufacturing process.

The system 5 removes the hydrocarbon content to derive the liquid and gaseous end products. Solid materials, such as carbon black, that remain on the conveying surface of the vibratory conveyor will be passed to the cooling chamber 70, where the materials are cooled before being released through the gas-tight outlet mechanism 80 into a collection hopper 85 for removal and downstream handling and processing.

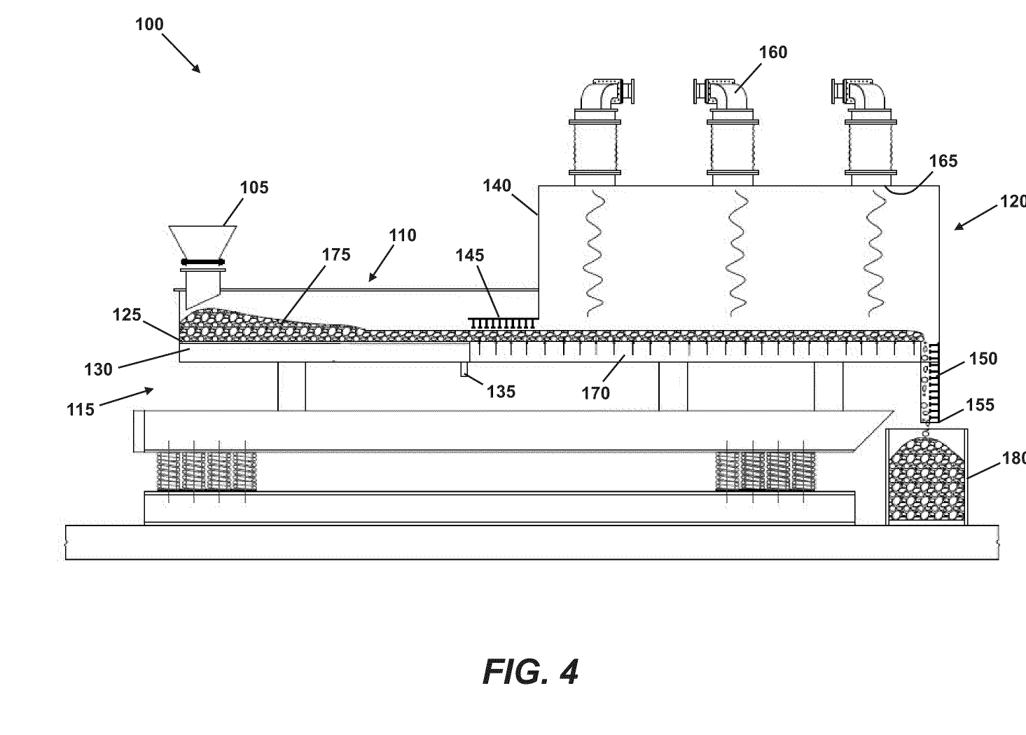

Various additional exemplary embodiments of microwave-based material processing systems according to the invention are depicted in FIGS. 4-7. As described above, microwave irradiation systems and methods according to the invention may be used in applications other than scrap tire conversion, such as heating, dewatering, drying, and sterilizing settings that may include, for example and without limitation, industrial or building materials manufacturing, food processing, wastewater treatment, environmental remediation, coal gasification and energy feedstock development (e.g., drying algae or cellulosic wood pulp to create an energy-producing feedstock for other processes). Other embodiments are also possible and, therefore, these exemplary embodiments are not to be construed as limiting in scope.

Another exemplary microwave-based material processing system 100 is shown in FIG. 4. This particular embodiment is designed for use in a dewatering application, although other uses may also be possible. Exemplary materials that may be dewatered using the system 100 of FIG. 1 include, without limitation, wastewater sludge and coal.

As shown, the system 100 includes a feed hopper 105 for receiving and distributing a material (feedstock) of interest. In this embodiment, the feed hopper 105 is located directly above a material receiving section 110 of the system 100. In other embodiments, the feed hopper 105 may be offset from the receiving section 110 of the system 100, in which case a conveyor, chute or some other device may be interposed between the feed hopper and the system inlet to transfer the feedstock therebetween. If desired, other materials such as coagulants that may be useful in dewatering wastewater sludge, may also be added using the feed hopper.

The feedstock material 175 is transferred from the receiving section 110 and transported through the system 100 by means of a vibratory conveyor 115, as described above. In this exemplary embodiment, the vibratory conveyor 115 extends the full length of the system 100—from the receiving section 110 through the microwave applicator chamber 120. In this case, at least the bottom of the conveying trough or table of the vibratory conveyor 115 includes a plurality of openings (e.g., perforations) through which water or another liquid contained within the feedstock may drain while being conveyed toward the microwave applicator chamber 120.

To assist with dewatering of the feedstock 175, this embodiment of the system 100 includes a drainage mechanism (e.g., dewatering grate) 125 that is located upstream of the microwave applicator chamber 120 and in a position over which the feedstock will be passed by the vibratory conveyor 115 prior to being irradiated. Consequently, at least some of the water or other liquid may drain from the feedstock through the vibratory conveyor trough or table and the underlying dewatering grate 125 prior to reaching the microwave applicator chamber 120. The draining liquid may pass into a liquid containment chamber 130 or a similar vessel located below the dewatering grate 125, from which it may be removed or allowed to flow through an exit port 135.

It can be seen that the microwave applicator chamber 120 of this exemplary embodiment is again a box-like structure having end walls 140, side walls and a top wall. In any case, the microwave applicator chamber 120 is preferably designed to prevent or reduce to an acceptable level, microwave energy leakage from the applicator chamber. Additionally, a pin-choke bed 145 or similar microwave blocking structure may be installed on the entry side of the applicator chamber 120 or elsewhere to similarly inhibit or eliminate the migration of stray microwave energy into adjacent spaces. For example, in this exemplary embodiment, a pin-choke bed 150 may also be installed along the material discharge port 155 of the microwave applicator chamber 120 to prevent stray microwave energy from leaving the system 100.

In this particular exemplary embodiment, the material discharge port 155 extends vertically downward from the microwave applicator chamber 120, which saves space. In other embodiments, material may be discharged from the microwave applicator chamber 120 into a cooling chamber or onto a discharge portion of the conveyor or another conveyor, which may extend substantially horizontally from the microwave applicator chamber.

The microwave applicator chamber 120 is shown to be associated with microwave waveguides 160 that direct microwave energy from a microwave source (not shown) through corresponding entry points 165 in the overhead wall of the microwave applicator chamber 120. The waveguides 160 and entry points 165 may have other shapes, locations and orientations in other system embodiments. The waveguides 160 may be protected from reflected microwave energy by any of the techniques that would be well known to one of skill in the art.

The exemplary system 100 shown in FIG. 4 also makes use of an optional fluidizing air flow that assists with drying the feedstock material 175 as it is simultaneously being heated and dried by microwave irradiation in the microwave applicator chamber 120. This feature may further reduce the liquid content of the material being dewatered or may reduce the required irradiation time. In this regard, the system 100 includes a plenum 170 that resides below the vibratory conveyor 115 in the area underlying the microwave applicator chamber 120 and receives a supply of warm (preferably) air (or other gas) from a source thereof. The warm air passes through the openings in the conveying surface of the vibratory conveyor 115 and circulates through the feedstock material residing within the microwave applicator chamber 120. In addition to mixing the feedstock material 175, the fluidizing air may directly assist with drying of the feedstock material, which may eliminate the need for a ceramic tile surface along the vibratory conveyor conveying surface and may lessen the required microwave irradiation time.

Although not shown in FIG. 4, a vapor (e.g., steam) extraction apparatus may also be placed in communication with at least the microwave applicator chamber 120. Such a vapor extraction apparatus may be a part of the system 100 itself or may be a separate and remotely located apparatus that is connected to the microwave applicator chamber 120 and possibly other portions of the system by appropriate tubing, etc. In any case, such a vapor extraction apparatus may be useful to extract steam and or other vapors that may be generated as the feedstock material 175 is irradiated.

After being sufficiently dried in the microwave applicator chamber 120, the dewatered feedstock material 175 is discharged through the discharge port 155. The dewatered material may be collected in a collection hopper 180 or any number of other containers or collection means for removal and downstream handling and processing.

As this exemplary embodiment does not make use of a sealed or purged internal environment (e.g., oxygen may be present), there is no need for an airtight seal along the system inlet or outlet.

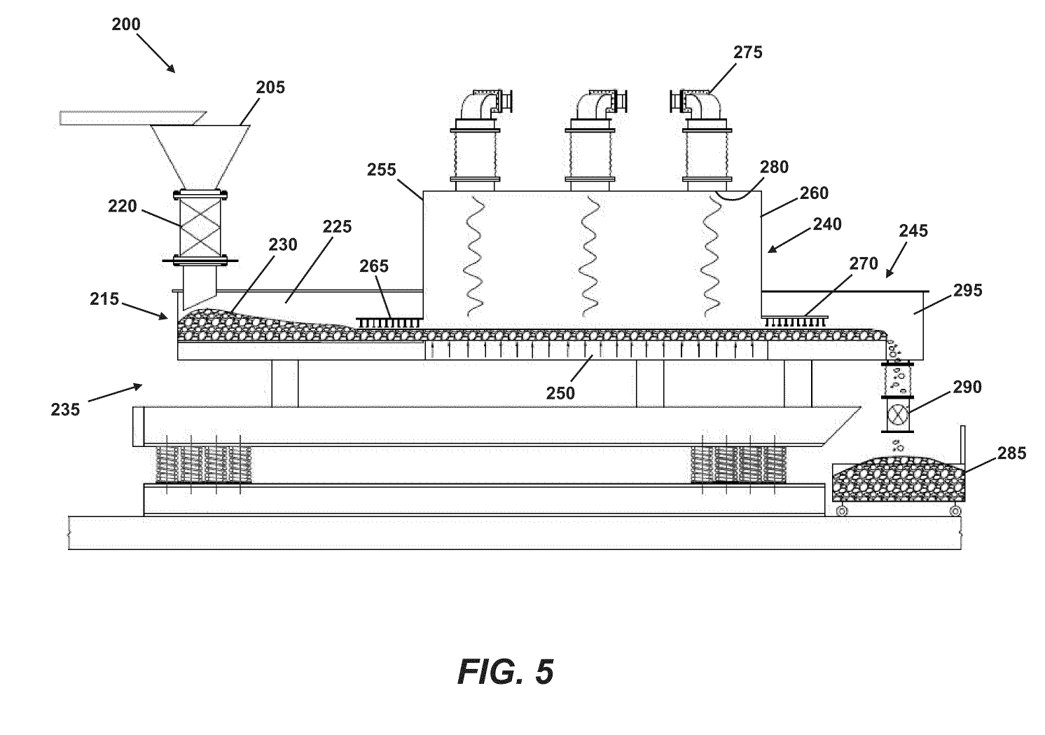

Another exemplary microwave-based material processing system 200 is shown in FIG. 5. This particular embodiment is designed for use in a sterilizing operation, although other uses may also be possible. The system 200 of FIG. 5 is particularly well-suited to the sterilization of foodstuffs, although the sterilization of other materials is also certainly possible.

As shown, the system 200 includes a feed hopper 205 for receiving and distributing a material (feedstock) of interest. In this embodiment, the feed hopper 205 is located directly above a material receiving section 215 of the system 200. In other embodiments, the feed hopper 205 may be offset from the receiving section 215 of the system 200, in which case a conveyor, chute or some other device may be interposed between the feed hopper and the system inlet to transfer the feedstock therebetween.

The inlet section 215 of the system 200 may include a sealed inlet mechanism 220 that helps to create a gas-tight feedstock receiving chamber 225 within the system. The gas-tight feedstock receiving chamber 225 may be purged, preferably with an inert gas.

The feedstock material 230 is transferred from the receiving section 215 and transported through the system 200 by means of a vibratory conveyor 235, as described above. In this exemplary embodiment, the vibratory conveyor 235 extends the full length of the system 200—from the receiving section 215 through the microwave applicator chamber 240 and discharge section 245. In this case, at least the bottom of the conveying trough or table of the vibratory conveyor 235 includes a plurality of openings (e.g., perforations).

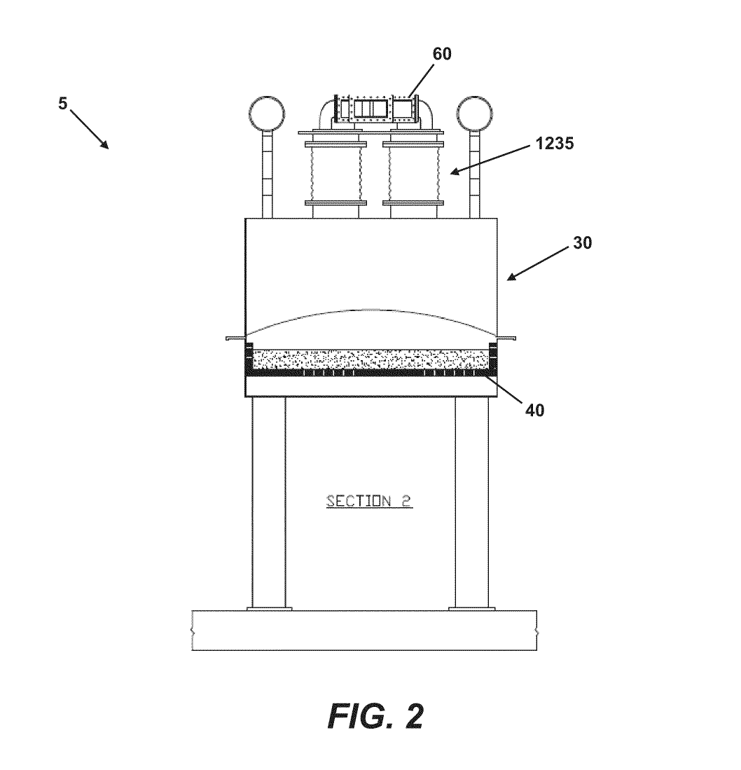

To assist with sterilization of the feedstock 230, this embodiment of the system 200 also makes use of an optional fluidizing gas flow. More particularly, this exemplary embodiment includes the use of a fluidizing flow of inert gas that is passed through the plurality of openings in the bottom of the conveying trough or table of the vibratory conveyor 135 while the feedstock is transported through the microwave applicator chamber 240. In this regard, the exemplary system 200 of FIG. 2 may further include a gas plenum 250 that resides below the vibratory conveyor 235 in the area underlying the microwave applicator chamber 240 to receive a supply of pressurized inert gas from a source thereof. The inert gas passes from the plenum through the openings in the conveying surface of the vibratory conveyor 235 and circulates through the feedstock material residing within the microwave applicator chamber 240. The effect of the fluidized flow of inert gas is to mix the feedstock, which allows for a more uniform absorption of microwave energy by the feedstock and may help to reduce the required irradiation time.

It can be seen that the microwave applicator chamber 240 of this exemplary embodiment is again a box-like structure having end walls 260, side walls and a top wall. In any case, the microwave applicator chamber 240 is preferably designed to prevent or reduce to an acceptable level, microwave energy leakage from the applicator chamber. Additionally, pin-choke beds 265, 270 or similar microwave blocking structure may be installed on either side of the applicator chamber 240 or elsewhere to similarly inhibit or eliminate the migration of stray microwave energy into adjacent spaces.

The microwave applicator chamber 240 is shown to be associated with microwave waveguides 275 that direct microwave energy from a microwave source (not shown) through corresponding entry points 280 in the overhead wall of the microwave applicator chamber 240. The waveguides 275 and entry points 280 may have other shapes, locations and orientations in other system embodiments. The waveguides 275 may be protected from reflected microwave energy by any of the techniques that would be well known to one of skill in the art.

After being sufficiently sterilized in the microwave applicator chamber 240, the processed feedstock material 230 is discharged to the discharge section 245, which may comprise a cooling chamber. The sterilized material may be collected in a collection hopper 285 or any number of other containers or collection means for removal and downstream handling and processing.

As this exemplary embodiment makes use of a sealed or purged internal environment (e.g., little to no oxygen is present), or may otherwise operate under vacuum, the outlet section 245 of the system 200 may include a sealed outlet mechanism 290 that helps to create a gas-tight discharge chamber 295. The discharge chamber 295 may also be purged, preferably with an inert gas.

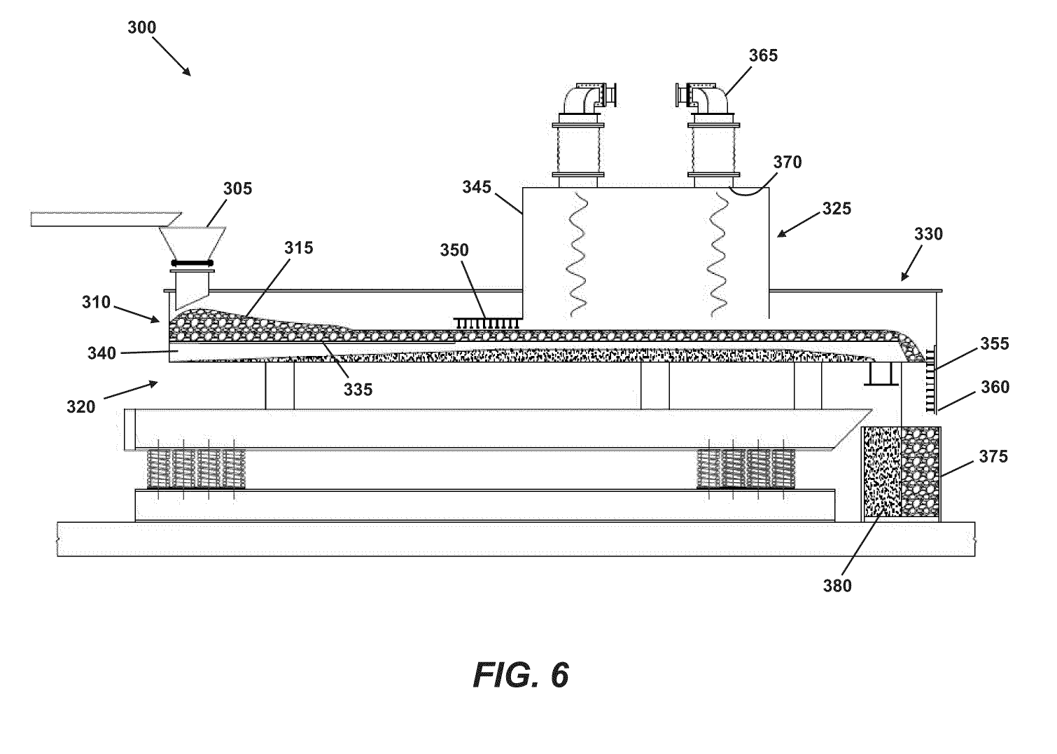

Another exemplary microwave-based material processing system 300 is shown in FIG. 6. This particular embodiment also includes sorting/sifting functionality. This particular embodiment is well-suited to use in applications such as heating or drying materials such as industrial or building materials used in cement kilns or asphalt plants, for treating wastewater sludge, for remediating contaminated soils, and for the preparation of foodstuffs or coal. The processing of other materials is also certainly possible.

As shown, the system 300 includes a feed hopper 305 for receiving and distributing a material (feedstock) of interest. In this embodiment, the feed hopper 305 is located directly above a material receiving section 310 of the system 300. In other embodiments, the feed hopper 305 may be offset from the receiving section 310 of the system 300, in which case a conveyor, chute or some other device may be interposed between the feed hopper and the system inlet to transfer the feedstock therebetween.

The feedstock material 315 is transferred from the receiving section 310 and transported through the system 300 by means of a vibratory conveyor 320, as described above. In this exemplary embodiment, the vibratory conveyor 320 extends the full length of the system 300—from the receiving section 310 through the microwave applicator chamber 325 and discharge section 330. In this case, at least the bottom of the conveying trough or table of the vibratory conveyor 320 includes a plurality of openings (e.g., perforations) through which small deleterious or otherwise undesirable material may pass prior to passage of the feedstock through the microwave applicator chamber 325.

The sorting/sifting functionality of this exemplary embodiment is provided by way of a sorting/sifting grate or screen 335 that is disposed in the conveying path of the feedstock material 315. The sorting/sifting grate or screen 335 is located upstream of the microwave applicator chamber 325 and in a position over which the feedstock 315 will be passed by the vibratory conveyor 320 prior to being irradiated. Consequently, smaller, deleterious or otherwise undesirable elements of the feedstock material 315 may be removed prior to microwave irradiation of the remaining, desirable portion of the feedstock material. The sorted/sifted material that passes through the sorting/sifting grate or screen 335 may be temporarily collected in a sorted/sifted material chamber 340 before being removed to another location.

It can be seen that the microwave applicator chamber 325 of this exemplary embodiment is again a box-like structure having end walls 345, side walls and a top wall. In any case, the microwave applicator chamber 325 is preferably designed to prevent or reduce to an acceptable level, microwave energy leakage from the applicator chamber. Additionally, a pin-choke bed 350 or similar microwave blocking structure may be installed on the entry side of the applicator chamber 325 or elsewhere to similarly inhibit or eliminate the migration of stray microwave energy into adjacent spaces. For example, in this exemplary embodiment, a pin-choke bed 355 may also be installed along the material discharge port 360 of the microwave applicator chamber 325 to prevent stray microwave energy from leaving the system 300.

In this particular embodiment, the material discharge port 360 extends vertically downward from the terminus of the discharge section 330. In other embodiments, the discharge side pin-choke bed 355 may instead be installed above the feedstock bed along the out-feed side of the microwave applicator chamber 325.

The microwave applicator chamber 325 is shown to be associated with microwave waveguides 365 that direct microwave energy from a microwave source (not shown) through corresponding entry points 370 in the overhead wall of the microwave applicator chamber 325. The waveguides 365 and entry points 370 may have other shapes, locations and orientations in other system embodiments. The waveguides 365 may be protected from reflected microwave energy by any of the techniques that would be well known to one of skill in the art.

After being sufficiently heated in the microwave applicator chamber 325, the processed feedstock material 315 is discharged to the discharge section 330, which may comprise a cooling chamber. The processed material may be collected in a collection hopper 375 or any number of other containers or collection means for removal and downstream handling and processing. The sorted/sifted material may also be discharged from the sorted/sifted material chamber 340 and collected in a collection hopper 380 or a similar container, which may be independent from or a separate portion of the collection hopper 375 in which the processed material is collected.

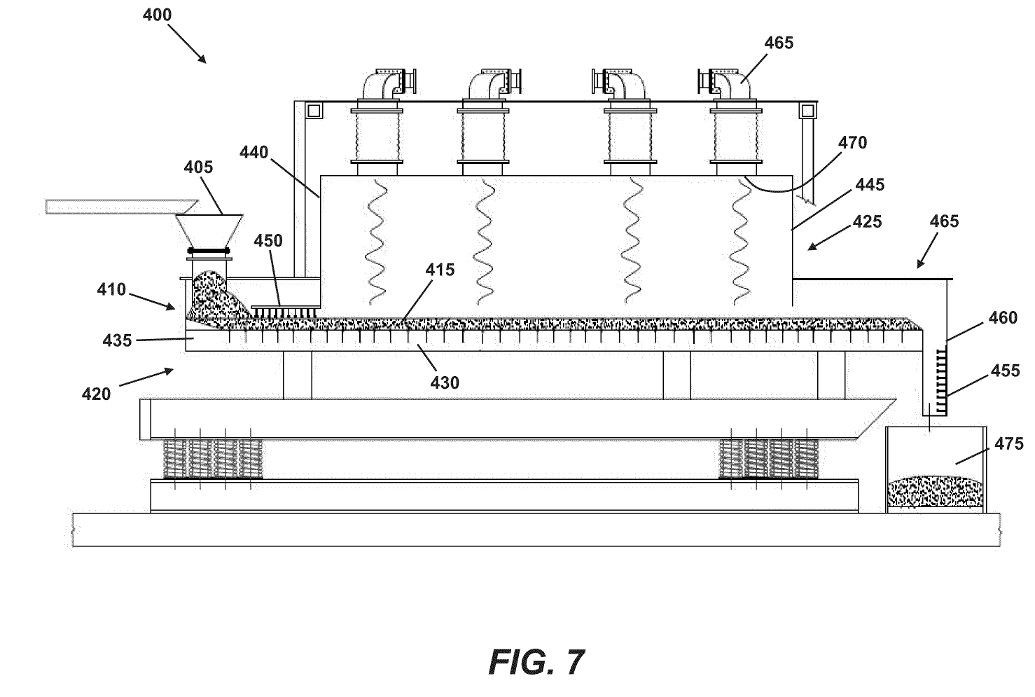

Yet another exemplary microwave-based material processing system 400 is shown in FIG. 7. This particular embodiment is designed for use in a drying application, although other uses may also be possible. Exemplary materials that may be processed using the system 400 of FIG. 7 include, without limitation, wastewater sludge, contaminated soils, coal and foodstuffs.

As shown, the system 400 includes a feed hopper 405 for receiving and distributing a material (feedstock) of interest. In this embodiment, the feed hopper 405 is located directly above a material receiving section 410 of the system 400. In other embodiments, the feed hopper 405 may be offset from the receiving section 410 of the system 400, in which case a conveyor, chute or some other device may be interposed between the feed hopper and the system inlet to transfer the feedstock therebetween.

The feedstock material 415 is transferred from the receiving section 405 and transported through the system 400 by means of a vibratory conveyor 420, as described above. In this exemplary embodiment, the vibratory conveyor 420 extends the full length of the system 400—from the receiving section 410 through the microwave applicator chamber 425. In this case, at least the bottom of the conveying trough or table of the vibratory conveyor 420 includes a plurality of openings (e.g., perforations) through which warm air (or another gas) may be passed while the feedstock passes through the system 400.

To assist with drying of the feedstock 415, this embodiment of the system 400 makes use of a fluidizing air flow. Unlike the previously described exemplary embodiments, wherein the fluidizing bed resides only below the microwave applicator chamber, the fluidized bed 430 of this exemplary embodiment extends along substantially the entire length of the system. This feature helps to dry the feedstock 415, thereby reducing the required irradiation time. To this end, the system 400 includes an air plenum 435 that resides below the vibratory conveyor 420 and receives a supply of a warmed air from a source thereof. The warm air passes through the openings in the conveying surface of the vibratory conveyor 420 and circulates through the feedstock material as it is conveyed through the system 400.

It can be seen that the microwave applicator chamber 425 of this exemplary embodiment is again a box-like structure having end walls 445, side walls and a top wall. In any case, the microwave applicator chamber 425 is preferably designed to prevent or reduce to an acceptable level, microwave energy leakage from the applicator chamber. Additionally, a pin-choke bed 450 or similar microwave blocking structure may be installed on the entry side of the applicator chamber 425 or elsewhere to similarly inhibit or eliminate the migration of stray microwave energy into adjacent spaces. For example, in this exemplary embodiment, a pin-choke bed 455 may also be installed along the material discharge port 460 of the microwave applicator chamber 425 to prevent stray microwave energy from leaving the system 400.

In this particular embodiment, the material discharge port 460 extends vertically downward from a discharge section 465, which may be a cooling chamber.

The microwave applicator chamber 425 is shown to be associated with microwave waveguides 465 that direct microwave energy from a microwave source (not shown) through corresponding entry points 470 in the overhead wall of the microwave applicator chamber 425. The waveguides 465 and entry points 470 may have other shapes, locations and orientations in other system embodiments. The waveguides 465 may be protected from reflected microwave energy by any of the techniques that would be well known to one of skill in the art.

After being sufficiently dried in the microwave applicator chamber 425, the feedstock material 415 is discharged through the discharge port 460. The dried material may be collected in a collection hopper 475 or any number of other containers or collection means for removal and downstream handling and processing.

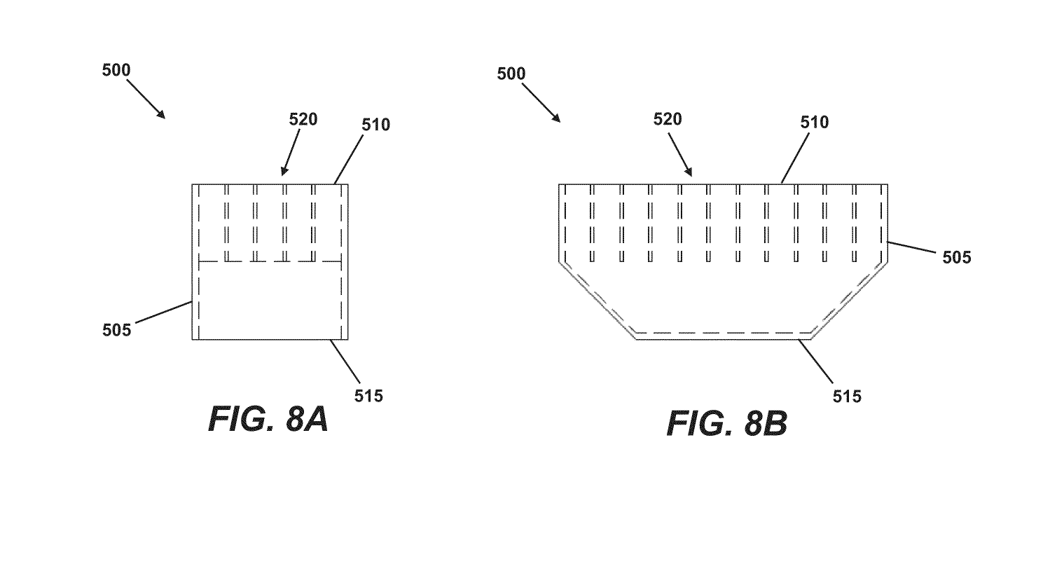

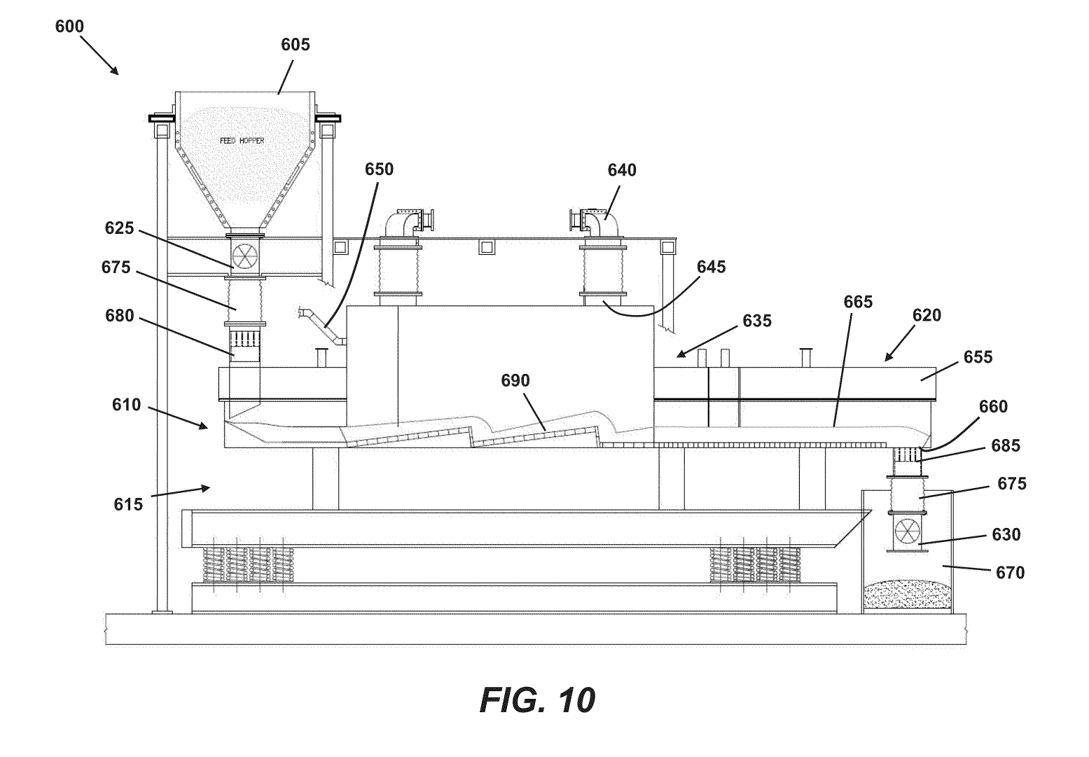

While the exemplary microwave-based material processing systems of FIGS. 1-7 have been shown and described as employing pin chokes to assist with the prevention or inhibition of unwanted microwave energy migration, it should be realized by those of skill in the art that the use of alternative microwave energy blocking or containment mechanisms are also possible. For example, FIGS. 8A-8B are a side view and a front view, respectively, of one exemplary embodiment of a pass-through microwave energy containment device 500 as used in the additional exemplary system embodiments of FIGS. 10-15 described below. As can be observed, this pass-through microwave energy containment device 500 includes a substantially hollow housing 505 having an open top 510 end and an open bottom end 515. Located within the housing 505 and between the top and bottom ends is a bundle or array 520 of tubes 525. The housing 505 may be the same length as the tubes 525, or may be longer than the tubes 525 as shown.

The cross-sectional dimension and length of the tubes 525 is dependent on the frequency of the microwave energy to be blocked. Generally speaking, the internal cross-sectional dimension of each tube 525 should be less than half the wavelength of the microwave energy to be blocked, and the length of each tube should be greater than twice the maximum cross-sectional dimension. Preferably, the length of each tube 525 should be at least four times its maximum cross-sectional dimension. Consequently, in an exemplary pass-through microwave energy containment device 500 designed to block microwave energy having a frequency of 915 MHz, the maximum square or round cross-sectional dimension of each tube should be about 3 inches and the maximum length of each tube should be between about 6 inches.

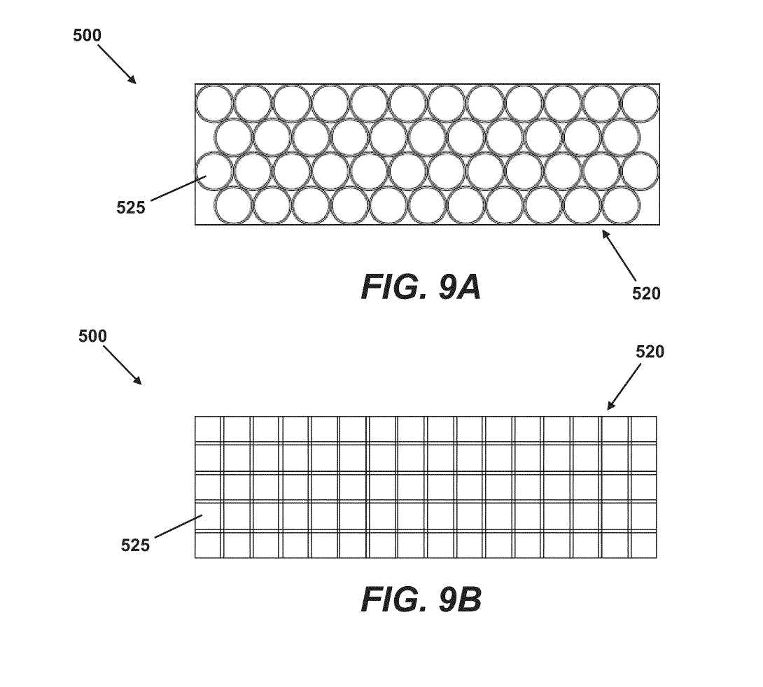

The cross-sectional shape of each tube 525, and the overall cross-sectional shape of the tube array 520 may vary. For example, as illustrated in FIGS. 9A-9B, the cross-sectional shape of each tube 525 of the array 520 may be round (FIG. 9A) or square (FIG. 9B). Other shapes are also possible, within the constraints of the aforementioned dimensional relationships. The cross-sectional shape of the tube array 520 may also vary, within the constraints of properly housing the tubes 525 and fitting into the appropriate port, pipe, conduit, etc., of a given microwave-based material processing system.

In any case, it should be understood that such a pass-through microwave energy containment device is able to advantageously block the unwanted migration of stray microwave energy while simultaneously allowing feedstock material or processed material to pass therethrough. Consequently, without the need to periodically shut off the microwave energy source, feedstock material may be continuously fed into and processed by a system that employs such a device(s), without any leakage of stray microwave energy and without the need for pin-choke beds or other known microwave energy blocking devices. It may be alternatively or also possible to place pass-through microwave energy containment devices at other locations in certain microwave-based material processing systems.

A first exemplary embodiment of a microwave-based material processing system 600 employing a pass-through microwave energy containment device is shown in FIG. 10. This particular embodiment is ideally designed for the microwave conversion of scrap tires. However, the system 600 may also be used to process other materials, such as without limitation, waste rubber from other products or manufacturing processes, waste plastics and polymers, asphalt shingles, e-waste, medical waste, municipal sludge, oil/shale drilling waste, coal (e.g., for gasification), and foodstuffs, and may also serve a role in systems and processes for producing activated carbon. A more detailed description of an exemplary scrap tire conversion system is described above with respect to the exemplary system embodiment shown in FIGS. 1-3.

As shown, this particular embodiment again includes a feed hopper 605 for receiving and distributing a material (feedstock) of interest. The feedstock material 690 is delivered to a receiving section 610 of the system 600 and subsequently transferred from the receiving section and through the system by means of a vibratory conveyor 615, as generally described above.

A gas-tight chamber may be created within the system by including a sealing mechanism 625, 630 at the inlet section 610 and an outlet section 620, respectively, of the system 600. The system 600, or sections thereof, may then be purged, preferably with an inert gas.

A microwave applicator chamber 635 is present and is shown to include microwave waveguides 640 that direct microwave energy from a microwave source (not shown) through corresponding entry points 645 in the overhead wall of the microwave applicator chamber 635. A gas port 650 or a plurality of gas ports may also be provided to vent gaseous byproducts of the microwave irradiation process from the microwave applicator chamber.

After being sufficiently irradiated in the microwave applicator chamber 635, the processed tire material may be transferred by the vibratory conveyor to a cooling chamber 655 where the material is allowed to cool sufficiently before being removed through a discharge port 660 therein. Alternatively, the processed tire material may be discharged directly from the microwave applicator chamber 635 to an external cooling apparatus. (not shown). The processed tire material 665 may be discharged into a material hopper 670, as shown.

It can be seen that a first pass-through microwave energy containment device 680 is associated with a portion of the feed hopper 605 to prevent microwave energy from migrating from the microwave applicator chamber 635 and exiting the receiving section 610. Similarly, a second pass-through microwave energy containment device 685 is associated with the discharge port 660 of the system 600 to prevent stray microwave energy from leaving the system through the discharge port. The design, construction and function of the pass-through microwave energy containment devices 680, 685 may be as described above and/or shown in FIGS. 8A-8B and 9A-9B, although other designs are also possible.

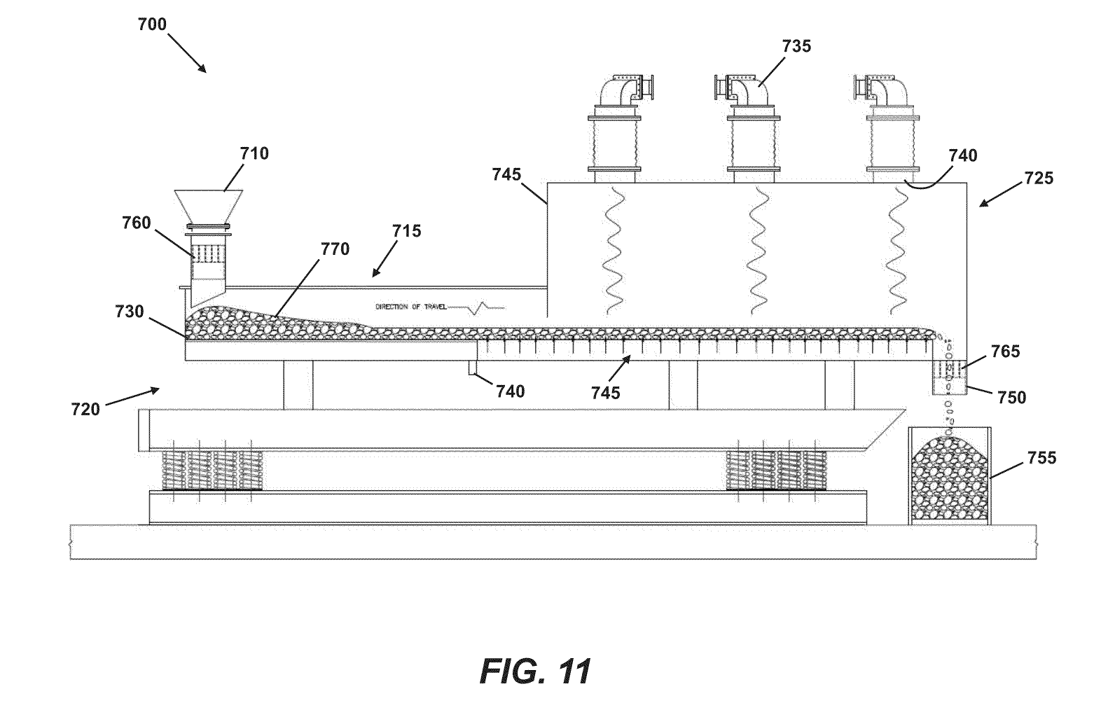

Another exemplary embodiment of a microwave-based material processing system 700 employing a pass-through microwave energy containment device is generally shown in FIG. 11. This particular embodiment is designed for use in a dewatering application, although other uses may also be possible. Exemplary materials that may be dewatered using the system 700 of FIG. 11 include, without limitation, wastewater sludge and coal. A more detailed description of an exemplary dewatering system is described above with respect to the exemplary system embodiment shown in FIG. 4.

As shown, the system 700 includes a feed hopper apparatus 710 for receiving and distributing a material (feedstock) of interest. If desired, other materials such as coagulants that may be useful in dewatering wastewater sludge, may also be added using the feed hopper. The feedstock material 770 is delivered to a receiving section 715 and subsequently transferred from the receiving section and through the system 700 by means of a vibratory conveyor 720, as generally described above. In this case, at least the bottom of the conveying trough or table of the vibratory conveyor 720 includes a plurality of openings (e.g., perforations) through which water or another liquid contained within the feedstock may drain while being conveyed toward the microwave applicator chamber 725. A drainage mechanism (e.g., dewatering grate) 730 is located upstream of the microwave applicator chamber 725 and in a position over which the feedstock will be passed by the vibratory conveyor 720 prior to being irradiated. The draining liquid may be removed or allowed to flow through an exit port 740 located subjacent to the dewatering grate 730.

The microwave applicator chamber 725 is shown to be associated with microwave waveguides 735 that direct microwave energy from a microwave source (not shown) through corresponding entry points (e.g., windows) 740 in the overhead wall of the microwave applicator chamber 725. This particular exemplary system 700 also makes use of an optional fluidizing air flow 745 that assists with drying the feedstock material 770 as it is simultaneously being heated and dried by microwave irradiation in the microwave applicator chamber 725. This feature may further reduce the liquid content of the material being dewatered or may reduce the required irradiation time. A vapor (e.g., steam) extraction apparatus may also be placed in communication with at least the microwave applicator chamber 725 to extract steam and or other vapors that may be generated as the feedstock material 770 is irradiated.

Once sufficiently dried in the microwave applicator chamber 725, the dewatered material is removed from the system. In this case, the dewatered material is discharged from the downstream end of the microwave applicator chamber 725 through a discharge port 750, whereafter it drops into a material hopper 755.

It can be seen that a first pass-through microwave energy containment device 760 is associated with a portion of the feed hopper 710 to prevent microwave energy from migrating from the microwave applicator chamber 725 and leaving the receiving section 715 of the system. Similarly, a second pass-through microwave energy containment device 765 is associated with the discharge port 750 of the microwave applicator chamber 725 to prevent stray microwave energy from leaving the system 700 through the discharge port.

Each of the first and second pass-through microwave energy containment devices 760, 765 may be designed and constructed as generally described above and/or as shown in more detail in FIGS. 8A-8B and 9A-9B, although other designs are also possible.

Uniquely, the pass-through microwave energy containment devices 760, 765 operate to block the unwanted migration of stray microwave energy while simultaneously allowing feedstock 770 material or processed material to pass therethrough. In the case of the first microwave energy containment device 760, feedstock material may pass through the device 760 and into the receiving section 715 of the system 700 regardless of whether an irradiation process is ongoing within the microwave applicator chamber 725. In the case of the second microwave energy containment device 765, processed material may be discharged through the device 765 and into the material hopper 755 regardless of whether an irradiation process is ongoing within the microwave applicator chamber 725. Consequently, without the need to periodically shut off the microwave energy source, feedstock material 770 may be continuously fed into and processed by the system 700—without any leakage of stray microwave energy and without the need for pin-choke beds or other known microwave energy blocking devices.

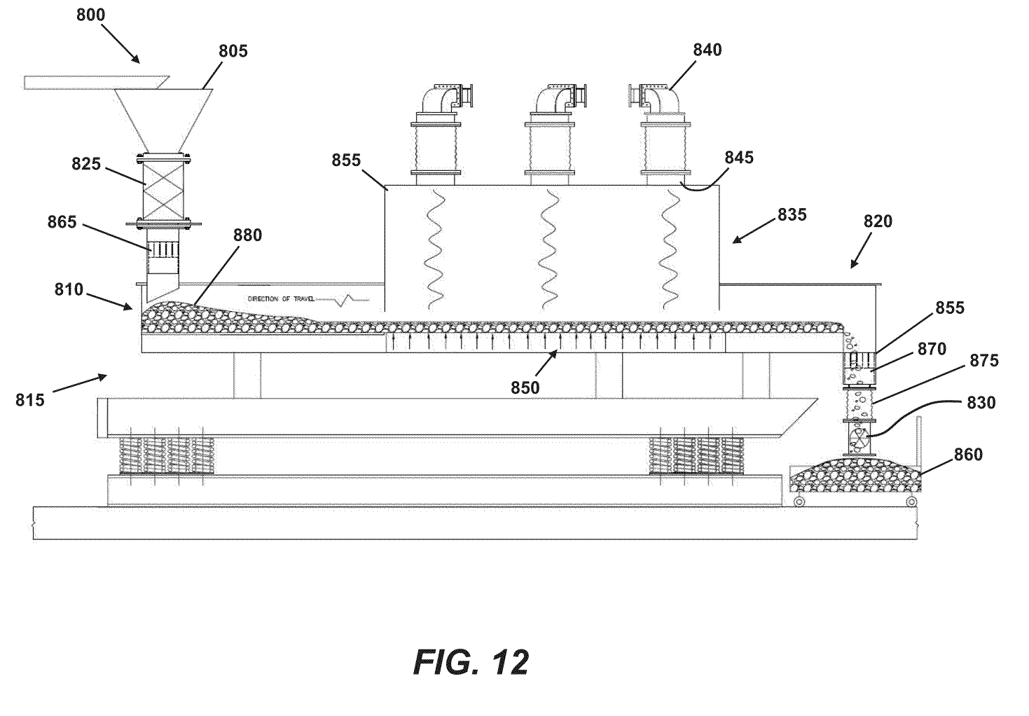

Another exemplary microwave-based material processing system 800 employing a pass-through microwave energy containment device is shown in FIG. 12. This particular embodiment is designed for use in a sterilizing operation, including but not limited to the sterilization of foodstuffs. A more detailed description of an exemplary sterilization system is described above with respect to the exemplary system embodiment shown in FIG. 5.

As shown, the system 800 includes a feed hopper apparatus 805 for receiving and distributing a material (feedstock) of interest. The feedstock material 880 is delivered to a receiving section 810 of the system 800 and subsequently transferred from the receiving section and through the system 800 by means of a vibratory conveyor 815, as generally described above.

The system 800 may be purged, such as with an inert gas, to assist with sterilization. To this end, both the inlet section 810 and outlet section 820 of the system 800 may include a sealing mechanism 825, 830 that helps to create a gas-tight feedstock receiving chamber 825 within the system.

The system 800 again includes a microwave applicator chamber 835, which is again shown to be associated with microwave waveguides 840 that direct microwave energy from a microwave source (not shown) through corresponding entry points 845 in the overhead wall of the microwave applicator chamber 835. To further assist with sterilization of the feedstock 880, this particular embodiment of the system 800 also makes use of an optional fluidizing flow of inert gas 850 that is passed through a plurality of openings in the bottom of the conveying trough or table of the vibratory conveyor 815 while the feedstock 880 is transported through the microwave applicator chamber 835.

After being sufficiently sterilized in the microwave applicator chamber 835, the processed material 880 is removed from the system. In this case, the sterilized material is discharged from the downstream end of the microwave applicator chamber 835 through a discharge port 855, whereafter it drops into a material hopper 860.

It can be seen that a first pass-through microwave energy containment device 865 is associated with a portion of the feed hopper 805 to prevent microwave energy from migrating from the microwave applicator chamber 835 and exiting the receiving section 810. Similarly, a second pass-through microwave energy containment device 870 is associated with the discharge port 855 of the microwave applicator chamber 835 to prevent stray microwave energy from leaving the system 800 through the discharge port. The design, construction and function of the pass-through microwave energy containment devices 865, 870 may be as described above and/or shown in FIGS. 8A-8B and 9A-9B, although other designs are also possible.

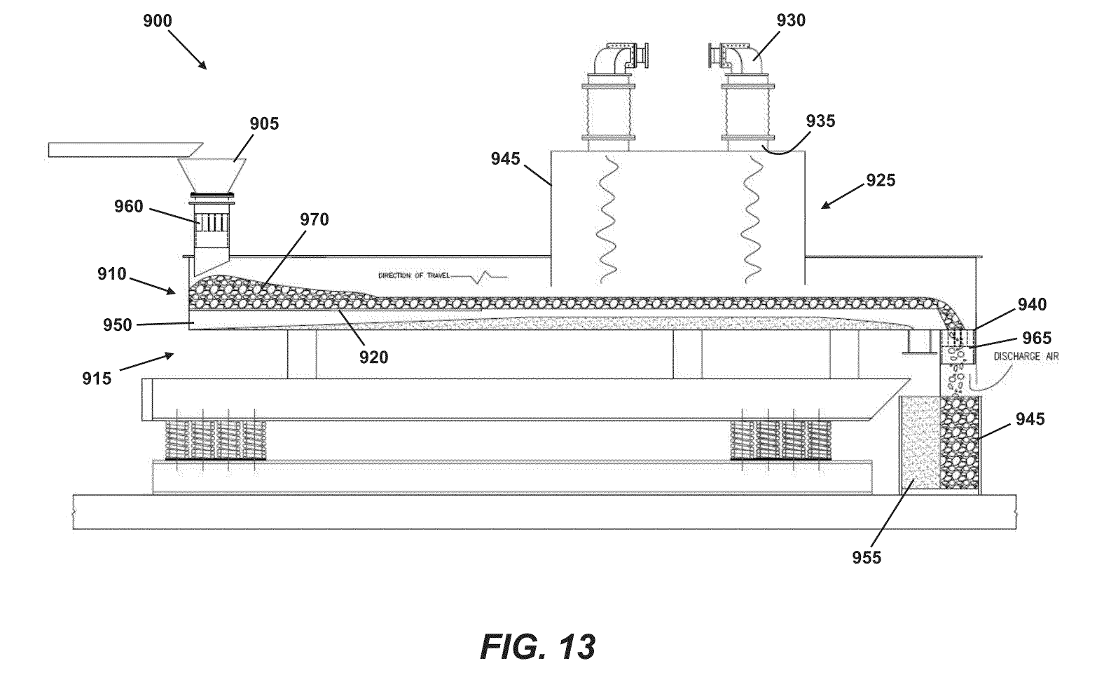

Another exemplary microwave-based material processing system 900 employing a pass-through microwave energy containment device is shown in FIG. 13. This particular embodiment also includes sorting/sifting functionality. A more detailed description of an exemplary microwave-based material processing system with sorting/sifting functionality is described above with respect to the exemplary system embodiment shown in FIG. 6.

As shown, the system 900 includes a feed hopper apparatus 905 for receiving and distributing a material (feedstock) of interest. The feedstock material 970 is delivered to a receiving section 910 of the system 900 and subsequently transferred from the receiving section and through the system 900 by means of a vibratory conveyor 915, as generally described above.

The sorting/sifting functionality of this exemplary embodiment is provided by way of a sorting/sifting grate or screen 920 that is disposed in the conveying path of the feedstock material 970. The sorting/sifting grate 920 separates smaller, deleterious or otherwise undesirable elements of the feedstock material 970 such that only a desirable portion of the feedstock material is irradiated.

The system 900 again includes a microwave applicator chamber 925, which is associated with microwave waveguides 930 that direct microwave energy from a microwave source (not shown) through corresponding entry points 935 in the overhead wall of the microwave applicator chamber 925. After being sufficiently heated in the microwave applicator chamber 925, the processed material is removed from the system. In this case, the processed material 970 is discharged from the downstream end of the microwave applicator chamber 925 through a discharge port 940, whereafter it drops into a material hopper 945. The sorted/sifted material may also be discharged from a sorted/sifted material chamber 950 of the system 900 and collected in a separate collection hopper, a segregated compartment 955 of the material hopper 945, or a similar container.

It can be seen that a first pass-through microwave energy containment device 960 is associated with a portion of the feed hopper 905 to prevent microwave energy from migrating from the microwave applicator chamber 925 and exiting the receiving section 910. Similarly, a second pass-through microwave energy containment device 965 is associated with the discharge port 940 of the microwave applicator chamber 925 to prevent stray microwave energy from leaving the system 900 through the discharge port. The design, construction and function of the pass-through microwave energy containment devices 960, 965 may be as described above and/or shown in FIGS. 8A-8B and 9A-9B, although other designs are also possible.

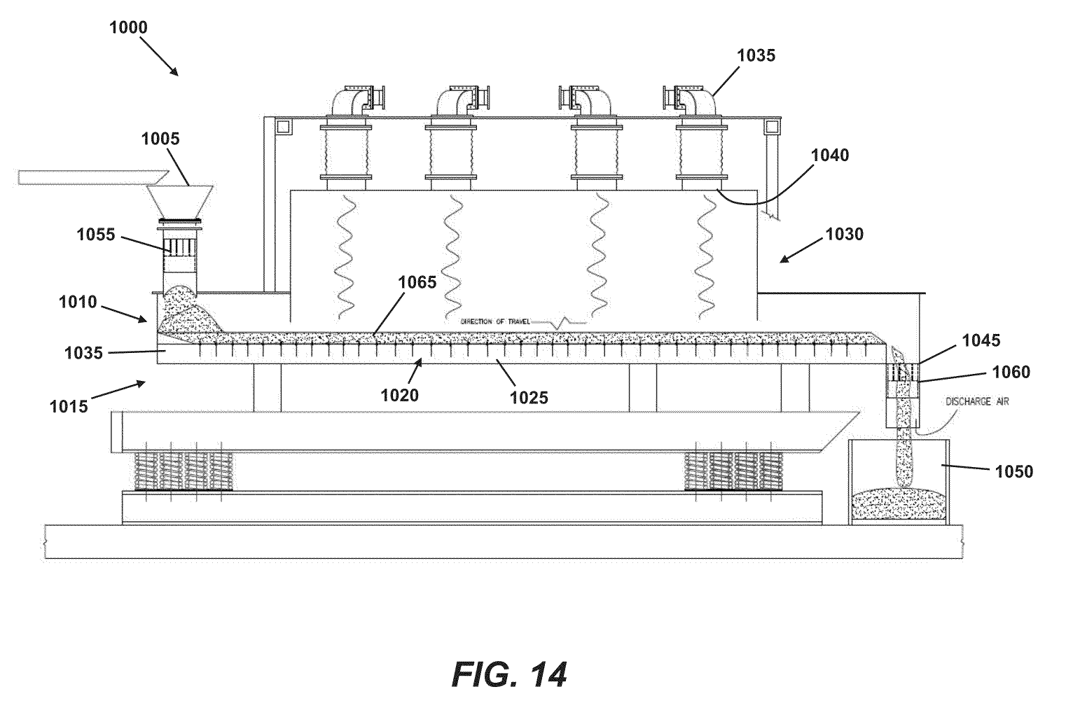

Yet another exemplary microwave-based material processing system 1000 employing a pass-through microwave energy containment device is shown in FIG. 14. This particular embodiment is designed for use in a drying application, although other uses may also be possible. A more detailed description of an exemplary microwave-based material drying system is described above with respect to the exemplary system embodiment shown in FIG. 7.

As shown, the system 1000 includes a feed hopper apparatus 1005 for receiving and distributing a material (feedstock) of interest. The feedstock material 1065 is delivered to a receiving section 1010 of the system 1000 and subsequently transferred from the receiving section and through the system 1000 by means of a vibratory conveyor 1015, as generally described above.

To assist with drying of the feedstock 1065, this embodiment of the system 1000 makes use of a fluidizing air flow 1020, which is distributed to the feedstock material 1065 by a fluidizing bed 1025 that extends along substantially the entire length of the system. This feature helps to dry the feedstock 1065, thereby reducing the required irradiation time.

The system 1000 again includes a microwave applicator chamber 1030, which is associated with microwave waveguides 1035 that direct microwave energy from a microwave source (not shown) through corresponding entry points 1040 in the overhead wall of the microwave applicator chamber 1030. After being sufficiently heated in the microwave applicator chamber 1030, the processed material is removed from the system. In this case, the dried material is discharged from the downstream end of the microwave applicator chamber 1030 through a discharge port 1045, whereafter it drops into a material hopper 1050.

It can be seen that a first pass-through microwave energy containment device 1055 is associated with a portion of the feed hopper 1005 to prevent microwave energy from migrating from the microwave applicator chamber 1030 and exiting the receiving section 1010. Similarly, a second pass-through microwave energy containment device 1060 is associated with the discharge port 1045 of the microwave applicator chamber 1030 to prevent stray microwave energy from leaving the system 1000 through the discharge port. The design, construction and function of the pass-through microwave energy containment devices 1055, 1060 may be as described above and/or shown in FIGS. 8A-8B and 9A-9B, although other designs are also possible.

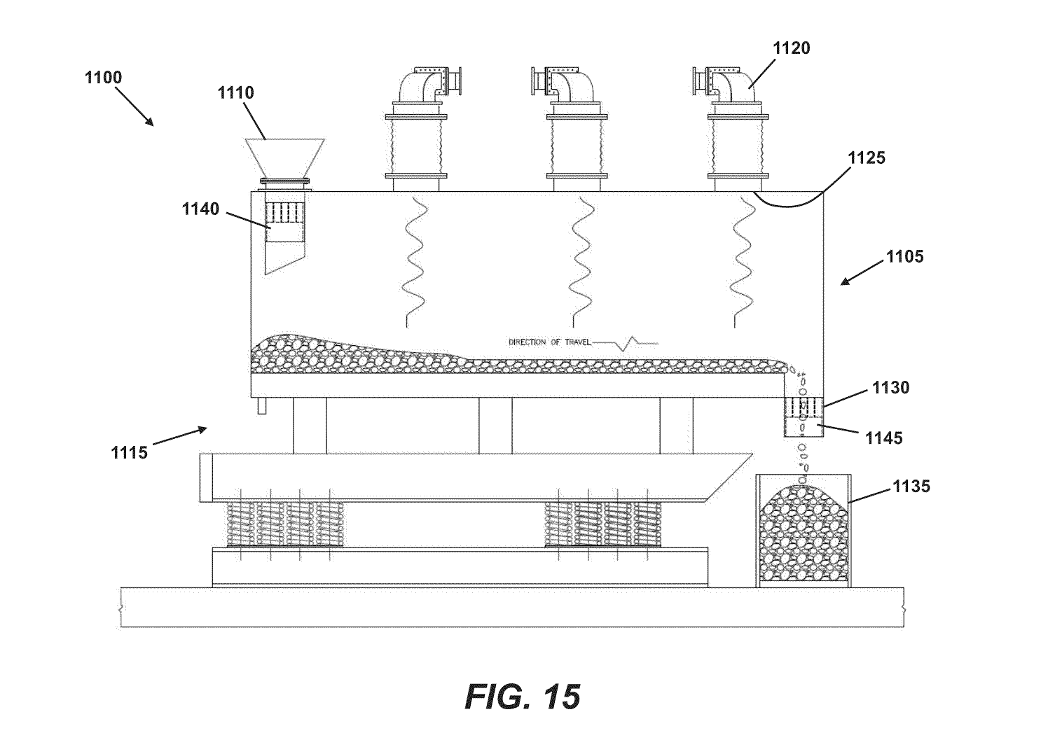

Referring now to FIG. 15, a very simplistic exemplary microwave-based material processing system 1100 may be observed. That is, this particular exemplary system 1100 lacks the material receiving section, cooling section, and various other features of the previously described and illustrated exemplary system embodiments.

Generally speaking, this exemplary system 1100 comprises only a microwave applicator chamber 1105, a feed hopper apparatus 1110 for supplying a material (feedstock) of interest to the microwave applicator chamber, and a vibratory conveyor 1115 that is located within the microwave applicator chamber 1105 and is operative to receive and transport the material of interest through the microwave applicator chamber as the material is irradiated, as generally described above. The feed hopper 1110 is associated with an opening in the overhead wall of the microwave applicator chamber 1105, such that the material of interest is introduced directly into the microwave applicator chamber and onto the vibratory conveyor 1115. The microwave applicator chamber 1105 again includes microwave waveguides 1120 that direct microwave energy from a microwave source (not shown) through corresponding entry points 1125 in the overhead wall of the microwave applicator chamber. After being sufficiently heated in the microwave applicator chamber 1105, the processed material is removed from the system. In this case, the dried material is discharged from the downstream end of the microwave applicator chamber 1105 through a discharge port 1130, whereafter it drops into a material hopper 1135.

It can be seen that a first pass-through microwave energy containment device 1140 is associated with a portion of the feed hopper 1110 to prevent microwave energy from migrating from the microwave applicator chamber 1105 and exiting the feed hopper 1110. Similarly, a second pass-through microwave energy containment device 1145 is associated with the discharge port 1130 of the microwave applicator chamber 1105 to prevent stray microwave energy from leaving the system 1100 through the discharge port. The design, construction and function of the pass-through microwave energy containment devices 1140, 1145 may be as described above and/or shown in FIGS. 8A-8B and 9A-9B, although other designs are also possible.

Each or any of the previously described exemplary system embodiments may also include a novel means for isolating various system components from the vibratory effects of the vibratory conveyor. For example, one exemplary specialized design and construction allows the waveguides of the microwave applicator to be secured in a stationary manner while simultaneously being isolated from the effects of the vibratory conveyor.

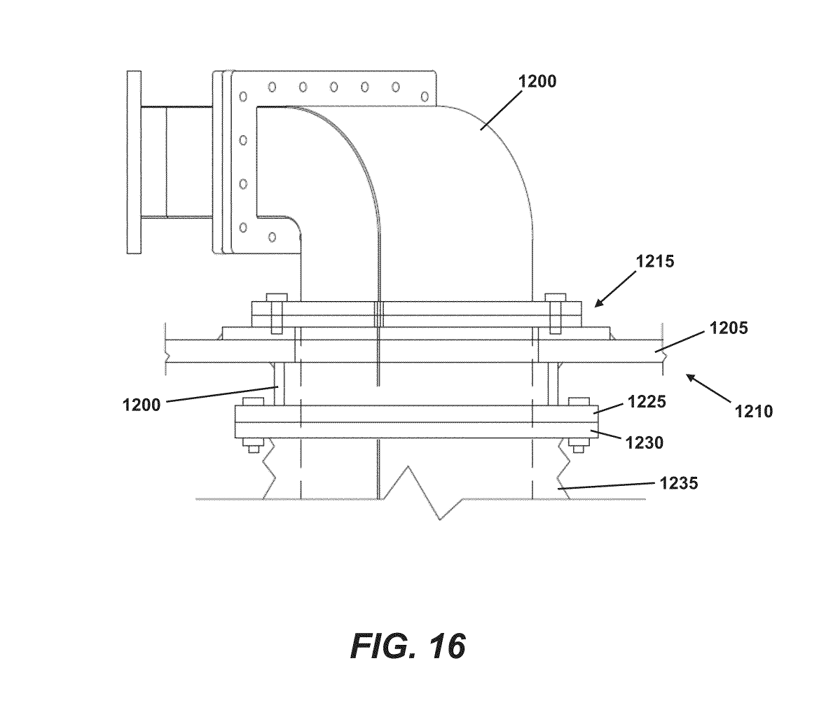

Referring now to FIG. 16, it can be observed that a unique connection and expansion joint construction may be employed for this purpose. Particularly, the waveguide 1200 is secured to a stationary support deck 1205 of the system frame 1210 by a flanged arrangement 1215. The support deck 1205 maintains the waveguide 1200 in a stationary position. A hollow pipe section 1220 is welded to the underside of the support deck 1205 so as to provide a sealed tunnel for the waveguide 1200 to pass through. A lower flange 1225 of the hollow pipe section 1220 connects to an upper flange 1230 of an expansion joint 1235, which also includes a lower flange 1240 (see particularly FIGS. 1-3, but also FIGS. 4-14) for connection of the expansion joint to a connector 1245 (see particularly FIGS. 1-3, but also FIGS. 4-14) extending from the upper wall of the particular microwave applicator chamber.

This design allows the vibratory movement of the vibratory conveyor to be absorbed by the expansion joint 1235 instead of being transferred to the waveguides 1200. This design also provides for a sealed waveguide pathway between the microwave source and the microwave applicator chamber. To this end, the expansion joints 1235 are preferably of metal construction, so as to contain both microwave energy and also any vapors that are produced during feedstock processing and migrate into the space sealed off by the expansion joints 1235.

A similar expansion joint design and construction may also be used to isolate other, upstream and/or downstream, components. For example, as shown at least in FIG. 1, an expansion joint 1235 is also located between the feed hopper 10 and the pre-heat chamber 25, as well as between the cooling chamber 70 and the outlet valve 80 of the system 5. A similar expansion joint may also be used to isolate gas/vapor recovery ducting from the vibratory effects of the vibratory conveyor. In one exemplary embodiment having one or more gas/vapor recovery ducts, an expansion joint may be located between each duct and its associated port on the microwave applicator chamber. In another exemplary embodiment having one or more gas/vapor recovery ducts, a manifold may be interposed between the ducts and the microwave applicator chamber, such that only a single expansion joint is needed between the manifold and the microwave applicator chamber.

In each of the exemplary system embodiments described above, at least the walls of the microwave applicator chamber are preferably comprised of a material that does not pass microwave energy, or the walls of the microwave applicator chamber may be otherwise lined or coated to produce the same effect. Furthermore, it is preferred that at least when the microwave application process will produce corrosive byproducts, at least the walls of the microwave applicator chamber are manufactured from a corrosion resistant material, such as 304 or 316L grade stainless steel.

With respect to the exemplary embodiments of FIGS. 1-7 and 10-15, the microwave applicator chamber has been described and shown as being substantially a box-like structure provided with a mechanism or mechanisms by which to emit and direct microwave energy onto a supply of moving material passing therethrough (i.e., to irradiate the material). It should be understood, however, that the microwave applicator chamber of other system embodiments need not have the same structure or shape, nor are the exemplary system embodiments of FIGS. FIGS. 1-7 and 10-15 necessarily limited to such a microwave applicator chamber design. Rather, as used in the broadest sense herein, the term “microwave applicator chamber” refers generally to any structure or apparatus that can be used to safely irradiate a moving supply of a material of interest. Further, it is to be understood that the microwave source that supplies microwave energy to a microwave applicator chamber of a system embodiment of the invention may be located remotely from the microwave applicator chamber, or may be associated with the microwave applicator chamber.

With respect to the exemplary embodiments of FIGS. 1-7 and 10-15, it can be seen that the in-feed side end wall of each microwave applicator chamber projects down to a point very near or in contact with the top of the feedstock layer (bed) being moved through the system. Such a design acts to inhibit or prevent microwave energy from undesirably leaving the microwave applicator chamber and entering the receiving section or passing to the outside environment. However, microwave-based material processing systems according to the invention are not so limited. Rather, other techniques may instead be used to prevent such microwave migration, including the pin chokes and alternative microwave energy containment devices described above. It is also possible to install a movable knife gate along the bottom edge of the in-feed side end wall of a microwave applicator chamber so as to minimize the gap between the applicator chamber wall and the feedstock bed while also being able to compensate for actually set different feedstock bed heights as the feedstock passes under the knife gate and into the microwave applicator chamber of the system.

It is described above that the microwave waveguides used to direct microwave energy from a microwave source into a microwave applicator chamber may be protected from reflected microwave energy. In one such exemplary but non-limiting design, pressurized gas may be pumped into the microwave applicator chamber in the area of the waveguide(s) to produce a gas blanket that discourages particles from contacting the window.

Other system features may also be provided. For example, liquid drip protection may be installed in the microwave applicator chamber (and elsewhere) to prevent any condensation that forms on the applicator walls during material irradiation from dripping down onto the material being processed. The drip protection may collect and route the condensation liquid back to the conveyor bed for evaporation by irradiation, or to another location that may or may not reside within the microwave applicator chamber.

Another system feature that may be provided is a baffle or baffles to prevent dried material particles from drifting or blowing back into the microwave applicator chamber after exiting therefrom into a discharge or cooling section. In one exemplary embodiment, a baffle is located along the top wall of a system discharge section enclosure.

Yet another system feature that may be provided is an arc detection safety interlock, which is operative to shut down the microwave applicator (i.e., microwave source) if arcing is detected within the microwave applicator chamber. For example, the arc detection safety interlock may operate by detecting the light of any plasma cloud that is produced within the microwave applicator chamber. When arcing is detected, the arc detection safety interlock quickly shuts down the microwave source or otherwise blocks additional microwave energy from entering the microwave applicator chamber so as to squelch the arcing and reduce or prevent the risk of damage to the system components.

In any system embodiment according to the invention, microwave energy may be transmitted to the microwave applicator chamber at a frequency between approximately 894 MHz and approximately 1,000 MHz, for example, at 915 MHz. Other frequencies are also possible. Further, the microwave energy may be transmitted to the microwave applicator chamber via bifurcated waveguides, such that the microwaves enter the microwave applicator chamber in parallel alignment. The microwave energy may be directed at the feedstock from above the vibratory conveyor and possibly also transversely thereto. In either case, it is contemplated that the microwave energy may be at least directed at an angle that is substantially perpendicular to the direction of travel of the feedstock.

While certain exemplary embodiments are described in detail above, the scope of the invention is not to be considered limited by such disclosure, and modifications are possible without departing from the spirit of the invention as evidenced by the following claims:

What is claimed is:

1. A microwave-based material processing system, comprising:
a microwave applicator chamber for irradiating a moving supply of feedstock material with microwave energy; and
a vibratory conveyor located to receive the feedstock material and adapted to transport the feedstock material through the microwave applicator chamber.

2. The system of claim 1, wherein the vibratory conveyor is confined to the microwave applicator chamber and the microwave applicator chamber is adapted to permit the feedstock material to be deposited onto the vibratory conveyor.

3. The system of claim 1, further comprising a material receiving section for receiving the feedstock material, the material receiving section located upstream of the microwave applicator chamber.

4. The system of claim 3, wherein a portion of the vibratory conveyor extends into the material receiving section and is operative to transport feedstock material from the material receiving section to the microwave applicator chamber.

5. The system of claim 2, further comprising a material feeding device adapted to supply the feedstock material to the material receiving section in a controlled manner.

6. The system of claim 1, wherein the vibratory conveyor includes a vibratory drive system that is operable to vary the speed at which the feedstock material is transported along a conveying surface of the vibratory conveyor.

7. The system of claim 1, further comprising a cooling chamber located downstream of the microwave applicator chamber, the vibratory conveyor further adapted to transport solid or semi-solid byproducts of irradiation through the cooling chamber.

8. The system of claim 1, further comprising a plurality of flexible and sealed expansion joints that are adapted to isolate at least microwave applicator waveguides of the system from the vibratory effects of the vibratory conveyor, while being simultaneously capable of containing any stray microwave energy and gases that are produced during the irradiation process.

9. The system of claim 1, further comprising at least one pass-through microwave energy containment device including a substantially hollow housing having an array of hollow tubes, the tubes being dimensioned to prevent the passage of microwave energy through the device while simultaneously permitting passage of feedstock material or processed material therethrough.

10. The system of claim 1, further comprising a vapor extraction apparatus in fluid communication with at least the microwave applicator chamber.

11. The system of claim 1, further comprising at least one ramp or other material mixing feature residing in the conveyed path of the feedstock material and within the microwave applicator chamber.

12. The system of claim 1, wherein the feedstock material is shredded or pulverized scrap tire material.

13. A microwave-based material processing system, comprising:
an enclosure;
a material receiving chamber within the enclosure for receiving a feedstock material;
a microwave applicator chamber located downstream of the material receiving chamber and within the enclosure, the microwave applicator chamber adapted to receive microwave energy from a microwave source for irradiating a moving supply of the feedstock material; and
a vibratory conveyor for receiving feedstock material from the material receiving chamber and transporting the feedstock material through at least the microwave applicator chamber.

14. The system of claim 13, further comprising a material feeding device adapted to supply the feedstock material to the material receiving chamber in a controlled manner.

15. The system of claim 13, wherein the vibratory conveyor includes a vibratory drive system that is operable to vary the speed at which the feedstock material is transported along a conveying surface of the vibratory conveyor.

16. The system of claim 13, further comprising a cooling chamber located downstream of the microwave applicator chamber, the vibratory conveyor further adapted to transport solid or semi-solid byproducts of irradiation through the cooling chamber.

17. The system of claim 13, further comprising a plurality of flexible and sealed expansion joints that are adapted to isolate at least microwave applicator waveguides of the system from the vibratory effects of the vibratory conveyor, while being simultaneously capable of containing any stray microwave energy and gases that are produced during the irradiation process.

18. The system of claim 13, further comprising at least one pass-through microwave energy containment device including a substantially hollow housing having an array of hollow tubes, the tubes being dimensioned to prevent the passage of microwave energy through the device while simultaneously permitting passage of feedstock material or processed material therethrough.

19. The system of claim 13, further comprising a vapor extraction apparatus in fluid communication with at least the microwave applicator chamber.

20. The system of claim 13, further comprising at least one ramp or other material mixing feature residing in the conveyed path of the feedstock material and within the microwave applicator chamber.

21. The system of claim 13, wherein the material receiving chamber is also a pre-heat chamber that is operative to raise the temperature of the feedstock material before the feedstock material is transported to the microwave applicator chamber.

22. The system of claim 13, wherein the enclosure is sealed against outside air intrusion.

23. The system of claim 22, wherein the enclosure is pressurized with air or a gas that is substantially free of oxygen.

24. The system of claim 22, wherein the enclosure is evacuated.

25. The system of claim 13, wherein the feedstock material is shredded or pulverized scrap tire material.

26. A microwave-based material processing method, comprising:
providing a microwave-based material processing system, the system comprising:
a microwave applicator chamber for irradiating a moving supply of the feedstock material with microwave energy, and
a vibratory conveyor located to receive feedstock material and adapted to transport the feedstock material through the microwave applicator chamber,
providing feedstock material to the vibratory conveyor,
operating the vibratory conveyor to transport feedstock material through the microwave applicator chamber and irradiating the feedstock material for at least a portion of time that the feedstock material is located within the microwave applicator chamber; and
transporting solid or semi-solid byproducts of irradiation out of the microwave applicator chamber using the vibratory conveyor.

27. The method of claim 26, wherein the microwave-based material processing system further includes a cooling chamber downstream of the microwave irradiation chamber, and the vibratory conveyor of the system is used to transport solid or semi-solid byproducts of irradiation through the cooling chamber.

28. The method of claim 26, further comprising separating from solid or semi-solid portions of the irradiated feedstock material at least some of any gaseous and/or liquid byproducts of irradiation.

29. The method of claim 26, wherein the feedstock material is shredded or pulverized scrap tire material.

30. A microwave-based scrap tire conversion system, comprising:
an enclosure sealed against outside air intrusion;
a material receiving chamber within the enclosure for receiving shredded or pulverized scrap tire feedstock material;
a microwave applicator chamber located downstream of the material receiving chamber and within the enclosure, the microwave applicator chamber adapted to receive microwave energy from a microwave source via one or more waveguides and to irradiate a moving supply of the scrap tire material;
a cooling chamber located downstream of the microwave applicator chamber;
a material discharge port associated with the cooling chamber;
a vapor extraction mechanism for removing at least some of any gaseous byproducts of irradiation that are produced within the microwave applicator chamber;
a liquid separation mechanism for separating from solid portions of the irradiated scrap tire material at least some of any liquid byproducts of irradiation; and
a vibratory conveyor located to receive scrap tire material from the material receiving chamber, adapted to transport the scrap tire material through the microwave applicator chamber, and adapted to transport solid byproducts of irradiation through the cooling chamber and to the material discharge port.

31. The system of claim 30, wherein the vibratory conveyor includes a vibratory drive system that is operable to vary the speed at which the feedstock material is transported along a conveying surface of the vibratory conveyor.

32. The system of claim 30, further comprising a plurality of flexible and sealed expansion joints that are adapted to isolate at least the one or more microwave applicator waveguides of the system from the vibratory effects of the vibratory conveyor, while being simultaneously capable of containing any stray microwave energy and gases that are produced during the irradiation process.

33. The system of claim 30, further comprising a pass-through microwave energy containment device associated with each of the material receiving chamber and the material discharge port, each pass-through microwave energy containment device including a substantially hollow housing having an array of hollow tubes, the tubes being dimensioned to prevent the passage of microwave energy through the device while simultaneously permitting passage of scrap tire feedstock material or solid byproducts of irradiation therethrough.

34. The system of claim 30, further comprising at least one ramp or other material mixing feature residing in the conveyed path of the scrap tire material and within the microwave applicator chamber.

35. The system of claim 30, wherein the material receiving chamber is also a pre-heat chamber that is operative to raise the temperature of the scrap tire feedstock material before the feedstock material is transported to the microwave applicator chamber.

36. The system of claim 30, wherein the enclosure is pressurized with air or a gas that is substantially free of oxygen.

37. The system of claim 30, wherein the enclosure is evacuated.
